(19) United States
(12) Patent Application Publication
(10) Pub. No.: US 2024/0075440 A1
(43) Pub. Date: Mar. 7, 2024

(54) COMBINATION CRYSTALLIZER, FILTER, WASHER, DRYER DEVICE

(71) Applicant: ODH IP Corp., NEW YORK, NY (US)

(72) Inventors: Julian Paul Chesterman, Rockville, MD (US); Kersten Rapp, Rockville, MD (US)

(73) Assignee: ODH IP Corp., NEW YORK, NY (US)

(21) Appl. No.: 18/460,938

(22) Filed: Sep. 5, 2023

Related U.S. Application Data
(60) Provisional application No. 63/374,592, filed on Sep. 5, 2022.

(51) Int. Cl. B01F 35/00; B01D 29/78; B01D 29/80; B01F 27/231; B01F 27/90; B01F 35/30; B01F 35/51

(52) U.S. Cl. CPC B01F 35/187; B01D 29/78; B01D 29/80; B01F 27/2312; B01F 27/90; B01F 35/30; B01F 35/51; B01F 2035/351

(57) ABSTRACT

A combination crystallizer washer filter dryer device and methods of using the device for producing washed and dried product of a reaction are disclosed. The device consolidates the functions of a crystallizer with the filtering, washing, and drying steps to a single vessel, eliminating the need for an additional crystallizer separate from the filter washer dryer device, the transfer of a reaction product or crystallized product from a crystallizer to a subsequent vessel for completing the filtering, washing, and drying process of the solid phase of the slurry.

### CROSS-REFERENCE TO RELATED APPLICATIONS

This application claims priority from Provisional Application No. 63/374,592, filed Sep. 5, 2022, the entire contents of which are hereby incorporated by reference.

### GOVERNMENTAL RIGHTS

This invention was made with government support under DARPA Cooperative Award #HR-0011-16-2-0029 awarded by the Defense Advanced Research Projects Agency of the department of defense. The government has certain rights in the invention.

### FIELD OF THE INVENTION

The present invention provides a combination crystallizer filter washer dryer (CFWD) device and methods of using the device for producing washed and dried product of a reaction.

### BACKGROUND OF THE INVENTION

Crystallization is an important separation and purification process used in industries ranging from bulk commodity chemicals to specialty chemicals and pharmaceuticals. In recent years, a number of environmental applications have also come to rely on crystallization in waste treatment and recycling processes. Historically, processes that comprise a crystallization step are conducted in a crystallizer, and the resulting slurry comprising the crystalline phase and the liquid phase is then transferred to another vessel to undergo filtration, washing, and drying (e.g., centrifuge, rotary drum filter, etc.). The transfer of slurries is time-consuming and clogging of tubing can occur.

Conventional crystallizers have a geometry and stir blade designed to achieve good mixing of solutions and suspensions, but no capability to separate solids from the liquid except for stopping agitation, allowing solids to gradually settle out (slow), and pumping liquid from the top surface such that not all liquid can be removed. Consequently, crystallizers are normally paired with a filter washer dryer (FWD) unit that is customized for filtration and drying. In general, FWD units have a geometry that includes a squat, wide geometry with high surface area at the base (filter surface) and a slow-moving, high torque stir blade designed for agitating clumpy wet solids during drying rather than mixing liquids. The slurry generated in the crystallizer is transferred to the FWD by pouring or pumping. However, some reactions/precipitations/crystallizations form highly viscous slurries or gels that are challenging or impossible to transfer between separate reactor/crystallizer and FWD units. In addition, reactions, precipitations, or crystallizations that are conducted at elevated or chilled temperatures can be difficult to transfer to a second vessel due to factors such as viscosity or heating/cooling during transfer. Further, if systems are run in parallel, a valve can be required to redirect the slurry. These valves are limited in their material of construction and can lead to process contamination through extractable and leachable pathways. Slurry transfers are typically completed by applying a head-space pressure that creates a pressure differential that facilitates the transfer of the material from one vessel to another. This again requires access to equipment such as compressed gas tanks, pressure gauges, and pressure relief valves, among other equipment.

What is needed is a device that eliminates the transfer of crystallization material to a subsequent vessel, thereby eliminating the need for additional vessels, pumps, and other such processing equipment, thereby significantly simplifying and streamlining a process.

### SUMMARY OF THE INVENTION

One aspect of the instant disclosure encompasses a crystallizer filter washer dryer device. The crystallizer filter washer dryer device comprises a vessel defining a process chamber, the vessel comprising vessel walls, a vessel opening, a vessel lid operable to releasably seal the vessel opening, and a vessel base and a filter plate laterally disposed on the vessel base wherein the filter plate is operable to retain a crystalline fraction of a slurry comprising the crystalline fraction and a liquid fraction. The crystallizer filter washer dryer device also comprises an agitator assembly comprising: an impeller and agitator shaft, wherein the impeller is laterally disposed within the vessel above the filter plate, wherein the agitator shaft is attached at agitator shaft distal end to the impeller in the process chamber of the vessel and extends through a mixing port in the vessel in rotatable and axially slideable relation; and a motor attached to an agitator shaft distal end of the agitator shaft and operable to rotate the agitator shaft about its longitudinal axis. The vessel comprises a drain port in the vessel base for outflowing the liquid fraction of the slurry filtered through the filter plate.

In some aspects, the vessel base and vessel lid are releasably sealed to the vessel walls. The vessel wall material can be PEEK, Hastelloy™, Stainless Steel, glass, or HDPE, the vessel base material is PEEK, Hastelloy™, Stainless Steel, or HDPE, the seals are PTFE-coated Viton™, or any combination thereof.

In some aspects, the vessel walls comprise a sealing rim at the vessel opening, and wherein the vessel lid is releasably sealed by a gasket interposed between the vessel opening and the sealing rim of the vessel walls. The gasket can be an EPDM gasket, an FEP-encapsulated silicone gasket, a PTFE coated gasket, or a Kalrez-encapsulated gasket.

In some aspects, the impeller has no predetermined direction of rotation and is vertically movable to raise and lower the impeller. Further, the impeller can be operable to stir a crystallization process, keep the slurry in suspension during filtration, smoothen a filter cake's surface prior to applying spray wash, resuspend the cake during re-slurring, agitate the solids and remove cracks in the filter cake during drying, and any combination thereof. In some aspects, the impeller comprises blades at a 45° angle relative to the shaft of the agitator assembly, wherein the drive mechanism comprises a 01164 NANOTEC, NEMA 23 stepper motor with encoder, and wherein the agitator assembly shaft is connected to the motor using a Ruland PCR20-8-4-SS flexible coupling.

The filter plate can be a perforated support plate with filter mesh (metallic or non-metallic), welded multi-layer mesh, sintered wire mesh, or any combination thereof. In some aspects, the filter plate is a sintered C-22 Hastelloy™ filter plate with Inconel™ 625 or a 1- or 5-micron Dutch Weave sintered stainless steel filter plate.

The device of any one of the preceding claims, wherein the device further comprises a controller in functional communication with valves, sensors, and the agitator assembly.

### BRIEF DESCRIPTION OF THE FIGURES

FIG. 1 is a schematic representation of a combination crystallizer filter washer dryer (CFWD) device of the instant invention.

FIG. 2 is a photograph showing a side view of a CFWD device of the instant invention comprising glass vessel side walls.

FIG. 3 is a photograph showing a side view of a CFWD device of the instant invention comprising 316 Stainless steel vessel side walls.

FIG. 4 is a photograph showing a side view of an agitator shaft and an impeller of the instant invention. The impeller is attached at the distal end of the agitator shaft.

FIG. 5 is a photograph showing a side view of an agitator assembly of the CFWD device of the instant invention. The agitator shaft is shown extending through the mixing port in the vessel lid of the CFWD device.

FIG. 6 is a perspective view of an impeller of the instant invention.

FIG. 7 shows a side view of a CFWD device of the instant invention on a stand.

FIG. 8 shows a top perspective view of a stand for the CFWD device of the instant invention.

FIG. 9 shows a CFWD device in use in a pharmaceutical manufacturing process.

FIG. 10 shows a CFWD device in use in a pharmaceutical manufacturing process.

FIG. 11 schematically depicts a chemical synthesis process of cisatracurium besylate.

FIG. 12 schematically depicts a chemical synthesis process of midazolam.

FIG. 13A schematically depicts a chemical synthesis process of NCA, a reagent used in the process of FIG. 12.

FIG. 13B depicts a process flow diagram used in the synthesis of NCA using a system comprising a CFWD device of the instant invention.

FIG. 14A schematically depicts synthesis of DMPC, a reagent used in the process of FIG. 12.

FIG. 14B depicts a process flow diagram used in the synthesis of DMPC using a system comprising a CFWD device of the instant invention.

FIG. 15A schematically depicts synthesis of lactam, an intermediate in the process of FIG. 12.

FIG. 15B depicts a process flow diagram used in the synthesis of lactam using a system comprising a CFWD device of the instant invention.

FIG. 16A schematically depicts synthesis of AFP, an intermediate in the process of FIG. 12.

FIG. 16B depicts a process flow diagram used in the synthesis of AFP using a system comprising a CFWD device of the instant invention.

FIG. 17A schematically depicts synthesis of TCE, an intermediate in the process of FIG. 12.

FIG. 17B depicts a process flow diagram used in the synthesis of TCE using a system comprising a CFWD device of the instant invention.

FIG. 18A schematically depicts synthesis of TCA, an intermediate in the process of FIG. 12.

FIG. 18B depicts a process flow diagram used in the synthesis of TCA using a system comprising a CFWD device of the instant invention.

FIG. 19A schematically depicts synthesis of midazolam from TCA in the process of FIG. 12.

FIG. 19B depicts a process flow diagram used in the synthesis of midazolam from TCA using a system comprising a CFWD device of the instant invention.

FIG. 20 depicts a process flow diagram used in isolation of DIHA after initial crystallization using a system comprising a CFWD device of the instant invention.

### DETAILED DESCRIPTION

The devices, systems, methods, and computer program products for data collection will be understood from the accompanying drawings, taken in conjunction with the accompanying description. It is noted that, for purposes of illustrative clarity, certain elements in various drawings may not be drawn to scale. Several variations of the system are presented herein. It should be understood that various components, parts, and features of the different variations may be combined together and/or interchanged with one another, all of which are within the scope of the present application, even though not all variations and particular variations are shown in the drawings. It should also be understood that the mixing and matching of features, elements, and/or functions between various variations is expressly contemplated herein so that one of ordinary skill in the art would appreciate from this disclosure that the features, elements, and/or functions of one variation may be incorporated into another variation as appropriate, unless described otherwise.

### I. Device

One aspect of the present invention encompasses a device that combines the functions of a crystallizer with the functions of a filter, washer, dryer (CFWD) device. The device functions as a crystallizer for the production of crystalline products through the formation of a suspension of growing particles in a liquid phase solution during a crystallization process. The device provides the necessary conditions for crystal nucleation and growth of crystallized solids having the desired quality. The device can then be used to separate the solid phase crystals from the liquid phase of the process, followed by washing and drying the solid phase. By consolidating the functions of a crystallizer with the filtering, washing, and drying steps to a single vessel, the CFWD eliminates the need for an additional crystallizer separate from the filter washer dryer device for the transfer of a reaction product or crystallized product from a crystallizer to a subsequent vessel for completing the filtering, washing, and drying process of the solid phase of the slurry. This reduces non-value-added time required for transferring of slurry, mitigates the need for a significant quantity of extra process equipment such as pumps or pressurized gases to push a slurry to a filtration vessel, reduces the potential for clogging of lines and valves, and reduces the potential of contamination from impurities extracted/leached from these materials. Combining the functions of a crystallizer, filter, washer, and dryer device would be ideal for miniature chemical or pharmaceutical manufacturing units, a pharmaceutical on demand (POD) unit where space and automation of a process are valued.

The CFWD device of the instant invention can also function as a reactor to carry out any chemical or biological reaction or fermentation where agitation and controlled reaction parameters are required, and where a product of the reaction is a slurry comprising solid phase crystals and a liquid phase, with the desired material having the option of being in either phase.

The CFWD device of the instant invention comprises a vessel defining a process chamber, a vessel base, a filter plate disposed across the flow path of a liquid into and out of the vessel, a vessel lid, an agitator assembly, a drain port in the vessel base for outflowing the liquid phase of the slurry filtered through the filter plate, and optionally a solids discharge port in the vessel operable to remove the crystal fraction of the slurry retained by the filter plate. It will be recognized that the CFWD device can further comprise additional components or parts known to individuals of skill in the art suitable for the intended function of the crystallizer. Non-limiting examples of additional components or parts can be as described herein further below in Section I(e).

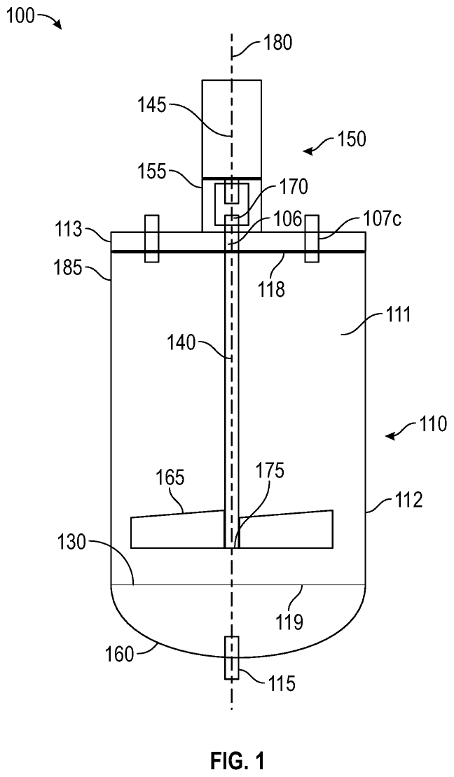

FIG. 1 is a schematic representation of a CFWD device of the instant invention. An operational sequence of a CFWD in a chemical process generally comprises the following steps: (1) crystallization, optionally preceded by reaction, (2) filtration, (3) cake washing, optionally (4) repulping, optionally (5) pressure or vacuum drying, optionally (7) cake discharge, and optionally (8) cake dissolution for discharge as a solution. It will be understood by those of skill in the art that the sequence is dependent on the desired specifications of target synthesized crystals, and these sequence steps can vary in their order.

The CFWD device is well suited for handling flammable, toxic, corrosive and odor-noxious materials, as the device provides product isolation, minimal operator exposure, reduced product handling, provides for very high solvent recovery, and environmental protection against solvent vaporization. Additionally, the level of containment supplied can comply with GMP and other health and safety requirements that chemical and pharmaceutical industries often face. The CFWD device can be designed to operate under vacuum and/or pressure. For all these reasons, the CFWD device can be used in pharmaceutical, fine chemical, dye and paint production, industrial chemical processes, and wastewater treatment applications.

As described further below, one or more of the CFWD devices of the present invention can be included in a reactor module. As used herein, the term “reactor module” refers to a CFWD device of the instant invention, optionally further comprising other components such as such as sensors, filters, connectors, probes, samplers, connectors for attaching the reactor to additional devices or systems, or any combination thereof. Other additional components can be as described in Section I(e) herein further below, and can be connected or associated with other devices used in a process for producing a chemical product, such as reservoirs, heaters, valves, flow meters, filter-washer-dryers, combination reactor filter-washer-dryer devices, waste reservoirs, separators, purification devices, pumps, inline mixers, pressure transducers, controllers, mixing chambers, tube style or plug-flow reactors, or any combination thereof.

It will be understood that all the components of the CFWD can be constructed from materials that meet the requirements of a desired process. The components can be constructed of the same or different materials based on the intended use of the reactor, and are known to individuals of skill in the art. Non-limiting examples of materials include metals, including but not limited to steel, metal alloys such as Hastelloy™ and Inconel™, stainless steel, and aluminum, as well as glass, ceramics, and plastics such as polyetheretherketone (PEEK), high density polyethylene (HDPE), polypropylene (PP), and fluoropolymers such as PVF (polyvinylfluoride), PVDF (polyvinylidene fluoride), PTFE (polytetrafluoroethylene; Teflon™), PCTFE (polychlorotrifluoroethylene), PFA or MFA (perfluoroalkoxy polymer), FEP (fluorinated ethylene-propylene), ETFE (polyethylenetetrafluoroethylene), ECTFE (polyethylenechlorotrifluoroethylene), FFPM/FFKM (perfluorinated elastomer [perfluoroelastomer]), FPM/FKM (fluoroelastomer [vinylidene fluoride based copolymers]), FEPM (fluoroelastomer [tetrafluoroethylene-propylene]), PFPE (perfluoropolyether), perfluoropolyoxetane, or any combination thereof. In some aspects, it is beneficial to construct the components from or comprise portions made of thermally conductive material or material that can withstand positive or negative pressures that may be applied to the process chamber.

(a) Crystallizer

Crystallization is a chemical solid-liquid separation technique, in which mass transfer of a solute from the liquid solution to a pure solid crystalline phase occurs. Crystallization is therefore related to precipitation, although the result is not amorphous or disordered, but a crystal. The quality of a crystalline product can be defined by the kind of crystalline phase produced, crystal size and crystal size distribution, crystal morphology, and product purity.

The quality of a crystalline product is important for its intended use. For instance, if further processing of the crystals is desired, large crystals with uniform size are important for washing, filtering, transportation, and storage, because large crystals are easier to filter out of a solution than small crystals. Also, larger crystals have a smaller surface area to volume ratio, leading to a higher purity. This higher purity is due to less retention of mother liquor which contains impurities, and a smaller loss of yield when the crystals are washed to remove the mother liquor. In some cases, for example during drug manufacturing in the pharmaceutical industry, small crystal sizes are often desired to improve drug dissolution rate and bioavailability. The theoretical crystal size distribution can be estimated as a function of operating conditions with a fairly complicated mathematical process called population balance theory (using population balance equations).

In chemical synthesis processes, crystallization occurs in a crystallizer. These conditions can be achieved and controlled using predetermined operating parameters in the crystallizer to control formation of a crystalline product and quality aspects of the formed crystalline product. Non-limiting examples of such operating parameters include temperature, pressure, circulation rate, evaporation, addition of a second solvent to reduce the solubility of the solute (technique known as antisolvent or drown-out), solvent layering, sublimation, changing the cation or anion, or any combination thereof. These parameters can be used to control nucleation, density of nuclei, nucleation rate, nuclei density/crystallizer slurry density, growth rate, total number of crystals per unit volume, population average size, and the like. Accordingly, in a method of the instant invention, a CFWD device of the instant invention can maintain such operating parameters to achieve a stable, predetermined, optimum crystal product output and purity, and to avoid process transients. For instance, the device comprises a volume and geometry conducive for efficient and controlled crystallization of compounds. Importantly, the device of the instant invention can maintain the parameters used to achieve the desired crystal quality, all while also maintaining the ability to perform the filtration, washing, and drying functions which were not compatible with crystallization before the invention was made. Non-limiting examples of CFWD devices and crystallization parameters that can be used with the CFWD devices to produce crystals comprising the desired qualities can be as described in the Examples section herein below. It will be noted that conditions in the CFWD device can also be adjusted to form a precipitate comprising an amorphous or disordered arrangement of molecules. Accordingly, a CFWD device of the instant disclosure can also be used to form a precipitate if desired.

(b) Vessel

The CFWD device of the instant invention comprises a vessel. The vessel defines a process chamber where a crystallization process occurs. The vessel comprises vessel walls, a vessel opening, a vessel lid operable to releasably seal the vessel opening, and a vessel base.

The vessel top, the vessel base, or both can be removably sealed to the walls of the vessel. Alternatively, the vessel top, the vessel base, or both can be in one part with the vessel walls. In some aspects, the vessel top and the vessel walls are in one part, and the vessel base is removably sealed to the walls of the vessel. In other aspects, the vessel base and the vessel walls are in one part, and the vessel top is removably sealed to the walls of the vessel. In yet other aspects, the vessel base, the vessel walls and the vessel top are in one part. In some aspects, the vessel top and the vessel base are removably sealed to the walls of the vessel (See, e.g., FIGS. 1-10).

When the vessel base, the vessel top, or both are releasably sealed to the vessel walls, the vessel top and/or base can be releasably sealed to the vessel walls by a mechanical closure. Suitable mechanical closures are known in the art and generally engage and connect the vessel walls and the vessel base or vessel top to bring the vessel base or vessel top into sealing contact with the rim of the vessel walls (the sealing rim) to form a seal at the point of contact between the vessel base or top and the rim of the vessel. Mechanical closures include those normally used in applications where purity, contamination, and cleanability are of paramount importance such as in the pharmaceutical industry, food industry, and the like. Non-limiting examples of mechanical closures include a sanitary clamp or other suitable union such as clamps or unions of conventional design, including band clamps, sanitary clamps such as Ladish, Tri-Clover clamps, Tri-Clamps, S-Clamps, 3A pipe fittings, mated threads on the vessel top or base and the vessel walls, nuts and bolts, clips, or any combination thereof. In some aspects, the vessel top and the vessel base are removably sealed to the walls of the vessel using tri-clamp fittings. In some aspects, the vessel walls are tri-clamp spools. In some aspects, the walls are tri-clamp sight glass spools.

The vessel walls, vessel lid, and vessel base of the CFWD device can be manufactured using any materials that meet the requirements of a desired process. The materials can be as described in Section I herein above. In some aspects, the CFWD vessel walls material, the lid material, or both are PEEK, Hastelloy™, Stainless Steel, HDPE, glass, or any combination thereof. In one aspect, the CFWD vessel wall material is 316 Stainless Steel. In some aspects, the vessel wall material is sight glass. In one aspect, the CFWD vessel base material is 304 Stainless Steel.

Seals, gaskets, and O-rings can also be designed and used to ensure a tight seal between the cover and sealing rim, as well as the shaft openings for one or more stirring shafts for the impeller. The material of the seals, gaskets, O-rings, or any combination thereof is generally inert to the reaction medium. For instance, the material can be elastomers, neoprene, EPDM rubber (ethylene propylene diene monomer rubber), coated elastomers such as fluoropolymer-coated elastomeric gaskets, such as PTFE-coated Viton™, and silicone encapsulated with fluorinated ethylene propylene (FEP) or a perfluoroelastomer such as Kalrez™. Other means of ensuring a fluid-tight seal between the cover and sealing rim can be envisioned. In some aspects, the vessel top and the vessel base are removably sealed to the walls of the vessel using seals, and the seals are PTFE-coated Viton™.

The CFWD device comprises a drain port in the vessel for outflowing a liquid from the vessel. The liquid can be a liquid phase (filtrate, mother liquor) of a slurry filtered through a filter plate disposed across the flow of the liquid. The liquid can also comprise solids retained in the vessel by a filter plate, then dissolved in a suitable solvent for transfer to other devices in a chemical synthesis process. In some aspects, the drain port is located in the vessel base under the filter plate to capture the liquid phase of the slurry. A filter plate of the instant invention can be as described in Section I(c) herein below. When the drain port is in the vessel base, the vessel base can function in a manner analogous to a reducer sanitary fitting of a piping system that allows the connection of pipes of unequal diameters. In this aspect, the base functions as a reducer by allowing the connection of the vessel comprising a first diameter with outflow tubing comprising a narrower diameter than the diameter of the vessel. Importantly, a vessel base of the instant invention can function as a reducer in a lower profile than reducers currently used in crystallizers thereby giving the CFWD device a compact footprint. This is especially useful when the CFWD is used in situations where space is limited, such as in a miniature chemical or pharmaceutical manufacturing unit.

In some aspects, when the vessel base and/or vessel lid are releasably sealed to the vessel wall, the crystals can be harvested from the CFWD device by releasing the vessel base and/or vessel top to access and harvest (offload) the crystals. Alternatively, the CFWD device can further comprise a solids discharge port in the vessel operable to remove the solid fraction of the slurry retained by the filter plate. The solids discharge port can be in the vessel wall at a location adjacent to the filter plate, in the vessel base, or both.

The size and shape of the vessel and the process chamber can and will vary based on the intended use of the CFWD device and equipment with which the device is used. For instance, the size and shape can be designed to accommodate optimal crystallization conditions to optimize a crystallization process, or to accommodate space restrictions in applications such as standalone chemical and pharmaceutical production systems. Similarly, the size and shape of the process chamber can and will vary considerably to accommodate a desired volume of reaction media or slurry in the process chamber. For instance, when the CFWD is operated as part of a batch system, the vessel's volume can be designed to accept an entire charge of slurry from upstream equipment to keep the idle time of the filter to a minimum. Sufficient holding volume is required for fast charging and emptying of the vessel.

As crystallizers can have uses in diverse fields such as within the food, chemical, and pharmaceutical industries, the size of a crystallizer vessel and process chamber can and will vary considerably. Reaction volumes of tens of thousands of liters are common. For instance, the process chamber can accommodate a volume of reaction media ranging from less than about 1 L to about 100 L or more.

In some aspects, the instant CFWD device can provide a process chamber that can accommodate a volume of reaction media ranging from less than about 150 mL to about 4 Ls or more. In some aspects, the instant crystallizer can provide a volume ranging from less than about 150 mL to about 3 L, from about 1 L to about 3 Ls, from about 1.5 L to about 3 L, from about 150 mL to about 400 mL, from about 150 mL to about 500 mL, from about 250 mL to about 750 mL, from about 500 mL to about 1.5 L, from about 500 mL to about 2 L, from about 750 mL to about 2 L, or from about 1.5 L to about 4 L. In some embodiments larger CFWD devices can be made with volumes ranging from 4L to 5L to 10L to 20L to 30L to 40L up to and including 50L.

In some aspects, the instant CFWD can provide a process chamber that can accommodate a volume of reaction media ranging from less than about 1 mL to about 4 Ls or more. In some aspects, the instant crystallizer can provide a volume ranging from less than about 250 mL to about 3 L, from about 250 mL to about 400 mL, from about 250 mL to about 500 mL, from about 250 mL to about 750 mL, from less than about 1 L to about 4 Ls or more, from less than 1 L to about 5 L or more, or from less than about 2 L to about 8 L or more. In some aspects, a process chamber can accommodate a volume of reaction media ranging from less than about 1.5 L to about 3.75 Ls or more. In some aspects, a process chamber can accommodate a volume of reaction media ranging from less than about 1.7 L to about 4.2 Ls or more. In some aspects, a process chamber can accommodate a volume of reaction media ranging from less than about 2.75 L to about 7 Ls or more.

The vessel walls, vessel top, and the vessel base can be constructed of the same or different materials based on the intended use of the CFWD device. Such materials are known to individuals of skill in the art. Non-limiting examples of materials can be as described herein above. In some aspects, the vessel walls, vessel top, vessel base, or any combination thereof, are constructed using thermally conductive material or material that can withstand pressures that may accumulate in the reaction chamber.

The vessel walls, vessel top, and vessel base can be constructed from or can comprise portions made of translucent/transparent material for observation during the reaction process, and/or to allow the user to direct specific electromagnetic energy at a specific wavelength into the crystallizer portion to participate in the reaction process. An example of electromagnetic energy can be UV light to help catalyze a polymerization reaction. Further, the translucent/transparent material can be measurement regions that can accommodate one or more detectors, or one or more conductive areas having different conductive properties. Non-limiting examples of detectors can be as described in Section I(e) herein below, and can include a camera, an optical microscope, an electron microscope, a spectrometer, or combinations thereof.

The vessel can further comprise additional components or parts known to individuals of skill in the art suitable for the intended function of the crystallizer. Non-limiting examples of additional components or parts can be as described herein further below in Section I(e).

(c) Filter plate

The CFWD device comprises a filter plate disposed across the flow path of a liquid into and out of the vessel, wherein the filter plate filters a slurry comprising a crystalline and a liquid fraction and retains the crystalline fraction of the slurry. The filter plate is generally attached to the vessel walls or vessel plate perpendicular to a longitudinal axis extending from the vessel lid to the vessel base. Accordingly, vessel walls and/or vessel base can comprise adapters or locating mounts to properly secure a filter plate to the vessel walls or vessel base.

Filter plates generally comprise, but are not limited to, the following properties: (1) an appropriate porosity (that is, the pores should be of such a size that allows sufficient flow of liquid and in some cases certain particle sizes; (2) chemical resistance to the reactants; (3) sufficient mechanical strength to withstand the pressures and vacuums exerted onto the plates; and (4) thermal resistance at the temperature at which the filtration is carried out. The type of filter plate can be determined based on the characteristics of the slurry, including the particular material in the slurry, the particle size and shape, the cake porosity, and compressibility, which are all factors that, when taken into account with the filter plate selected, will determine filtration rate.

The filter plate comprises porous material and can withstand the weight of the solids and the pressure that is exerted on the surface of the plate by the solids. Additional support for filter plates can be provided by support structures in the vessel base or the vessel walls. The filter plate can further comprise a perforated support onto which or into which the filter plate is placed. The filter plate can be welded to the base, the vessel walls, or both. Alternatively, the filter plate can be removably attached to the vessel base, vessel walls, or both.

Non-limiting examples of porous materials may include, but are not limited to: a) filtration fabric also known as “paper” or rolled goods; b) synthetic filtration fabrics often referred to as “non-wovens” such as polypropylene, polyethylene, polystyrene, and related polyolefins; fiberglass; polyamides such as nylon (6 and 6/6), KEVLAR, NOMEX; polyesters such as DACRON; polyacrylates, polymethacylates, polyacryonitrile such as ORLON, polyvinyl chlorides and related materials, such as polyvinylidene chloride; polytetrafluoroethylene (PTFE); polyurethanes; copolymers of the above materials, and combinations thereof; c) natural filtration fabric such as cellulose and other fiber-based air filters, wool, cotton, fiber glass, carbon fibers, and combinations thereof; d) metal filtration filters such as woven wire, perforated metal, and single or multilayered sintered metals; (e) woven fabric made from fibers such as cotton, nylon 6, polytetrafluorethylene (PTFE), nylon 6.6, nylon 11, nylon 12, HALAR ethylene chlorotrifluoroethylene (E-CTFE), polyester PBT, Polyester PET, polypropylene, acrylics, polyvinyl-den fluoride (PVDF), polyphosphate sulfide (PPS) and high density polyethylene, and any combination thereof. In some aspects, the filter plate is a sintered C-22 Hastelloy™ filter plate with Inconel™ 625. In some aspects, the filter plate is a sintered 0.5 micron Hastelloy plate. In other aspects, the filter plate is a 1 or 5 micron Dutch Weave sintered stainless steel filter plate.

The CFWD can comprise a single filter plate or more than one filter plate, each having different filtration properties. When the CFWD device comprises more than one filter plate, each filter plate can provide a stage of filtration by a specific particle size and be stacked to provide gradual reduction in filtration. The CFWD can comprise 1, 2, 3, 4, 5, 6, 7, 8, 9, 10 or more filter plates.

(d) Agitator Assembly

The CFWD of the instant invention comprises an agitator assembly for agitating the reaction media in the process chamber to ensure that sufficient agitation/stirring of a reaction medium can occur. Agitators can also be very useful in heat transfer applications when it is important that the fluid closest to the wall moves at high velocities. Suitable agitators are readily known to individuals of skill in the art. Non-limiting examples of suitable agitators include overhead stirrers and magnetic stirrers.

In some aspects, the agitator assembly is an overhead stirrer. An overhead stirrer generally comprises a shaft which extends through a port (mixing port) in the vessel into the reaction compartment and the reaction medium. The shaft comprises an impeller comprising impeller blades attached to the shaft. The shaft and impeller are disposed in the process chamber for stirring or agitating the reaction medium. For driving the stirrer, a drive mechanism such as a motor or other driving device may be employed, typically outside the crystallizer body. Any motor capable of providing the appropriate torque, speed and power can be used in a device of the instant disclosure. For instance, a motor of the instant disclosure can be a brushed DC electric motor, a brushless DC electric motor, a fractional horsepower motor, a servo motor, a three-phase AC synchronous motor, a stepper motor, a pneumatic motor, or any combination thereof. In some aspects, the motor is a stepper motor. In other aspects, the motor is a 12-24V stepper motor with a shaft diameter ranging from about 0.2 to about 1 inch. In one aspect, the motor is a 01164 NANOTEC, NEMA 23 STEPPER MOTOR WITH ENCODER, 24VDC, 264.81 OZ-IN TORQUE, 0.25IN DIA SHAFT. In another aspect, the motor is a Yamato LM200 stirrer attached to the vessel through a modified lid with a 24/40 connection.

It will be noted that a motor can further comprise parts operable to improve or adjust the performance of the motor or improve or adjust the connection of the motor to the agitator assembly and the vessel. For instance, the motor can further comprise a gearbox to adjust speed and torque to suit the needs of a process in the process chamber. For instance, a gearbox can be added to a motor to decrease the speed of the motor and increase the torque to suit process needs. Further, the motor can comprise a flexible coupling connecting the motor to the shaft of the agitator assembly. The function of a flexible coupling is to transmit torque from the motor to the agitator assembly shaft while making allowances for minor shaft misalignment and shaft end position changes between the two machines. In some aspects, the agitator assembly shaft is connected to the motor using a flexible coupling. In some aspects, the flexible coupling is a Ruland PCR20-8-4-SS. For additional stability of the stir blade, bearings could be added to the lid/motor coupling housing for a more rigid impeller.

Impellers can be classified as either laminar (viscous) or turbulent impellers. The type and geometry of impeller used will vary from process to process and can be determined experimentally. For situations involving very viscous fluids where laminar mixing is present, the diameter of the impeller can approach the diameter of the tank. The larger impellers aid in the transport of momentum throughout the tank and ensure that the fluid is moving close to the tank wall. Some common but non-limiting geometries of laminar impellers are the ribbon impeller, the screw impeller, and the anchor impeller.

Some common but non-limiting geometries for radial flow mixers include disk style flat blade turbines and curved blade turbines, while some common axial flow impellers are the propeller and pitched blade turbine. Turbulent mixers can be further categorized as axial or radial flow impellers, among other types. Axial flow impellers cause the tank fluid to flow parallel to the impeller's axis of rotation, while radial flow impellers cause the tank fluid to flow perpendicular to the impeller's axis of rotation. Axial flow impellers can be further broken down into paddle, turbine, screw-type, helical blade, anchor, gate propeller, to name but a few. Axial flow impellers are very useful in mixing solid-liquid suspensions because they prevent the solid particles from settling at the bottom of the tank. Radial flow impellers should be used in situations where high shear rates are needed, such as in dispersion processes.

The geometry, stir blade design, and slow mixing of currently available standard FWD units is not conducive to good mixing of solutions and can lead to longer reaction/precipitation times, increased particle size distribution, surface fouling, and other issues. For instance, standard FWDs are short and wide to maximize the filter surface area relative to the volume. However, this limits the rate of mixing that can be achieved without inducing significant vortexing. In addition, FWD impeller design and agitator motor selection are focused on achieving gradual high torque radial agitation of the solids in the filter cake to enhance drying. Consequently, FWD agitation does not provide the necessary agitation rates or axial flow typically needed during a crystallization process.

Conversely, agitation in an CFWD device of the instant invention is configured to optimize mixing of reaction components using agitation components and configurations known to individuals of skill in the art. Non-limiting examples of configuring agitation components to optimize mixing include impeller configuration, the addition of baffles in the reaction compartment, adjusting the mounting configuration of the stirrer, or any combination thereof. Agitator assemblies and crystallizer design that can provide efficient mixing can and will vary depending on the crystallizer type and size, the reaction medium characteristics, such as viscosity and volume of the reaction medium, and the stirring mechanism used, and are known to individuals of skill in the art. In a cylindrical crystallizer comprising a center-mounted mixer, a very inefficient flow pattern is generated: the tangential velocities from the impeller cause the entire fluid mass to spin. In other words, the entire fluid (and its solids) moves like a merry-go-round. In solid suspension applications, the solid particles will swirl around at the bottom of the tank: no axial (top to bottom) flow is created to lift them up and suspend them in the fluid. Accordingly, agitator assemblies and crystallizer design of a CFWD device can further comprise elements or can be configured to improve efficiency of mixing the reaction medium by the agitator. For instance, the angle of attachment of the impeller and impeller blades can be modified to suit a specific need. In some aspects, the angle of attachment ranges from about 15° to about 75°. This is in contrast to the standard 45° angle of attachment of impeller blades of currently available FWD devices.

In some aspects, an CFWD device of the instant invention further comprises baffles. As used herein, the term “baffle(s)” refers to structures in the reaction compartment to promote mixing by preventing vortexes from forming during agitation. Baffles can be long “plates” of various shapes, sizes, and configurations in the process chamber that prevent swirling & promote top to bottom fluid movement. They are most commonly used for blending and solid suspensions because these applications often use vertical, cylindrical tanks that tend to create swirling patterns, regardless of the type of impeller being used. Baffle configurations can and will vary depending on the crystallizer type and size, the reaction medium characteristics, such as viscosity and volume of the reaction medium, and the stirring mechanism used in conjunction with the baffles, and are known to individuals of skill in the art. For instance, the number of baffles, the width of baffles, and the mounting positions of the baffles in the reaction compartment are parameters that can be adjusted to get the best mixing. It is noted that square or rectangular blending tanks are self-baffling and may not need baffles. Baffles can be attached to the interior surface of the crystallizer vessel, the crystallizer lid, the impeller of the agitator, or any combination thereof. Efficient mixing can also be ensured by adjusting the mounting of the mixer in the process chamber. With axial-flow impellers, an angular off-center position where the impeller is mounted approximately 10-15° from the vertical, can be used. Alternatively, the mixer can be offset while being placed vertically in the tank. The mixer can also be positioned at an angle and offset.

The agitator assembly can also function during filtering, washing, drying, and discharging the crystalline compound as described herein above and below. For instance, the agitator assembly can comprise one or more impellers for stirring a reaction medium, keeping the slurry in suspension during filtration, smoothing the filter cake's surface prior to applying spray wash, resuspending the cake during re-slurring, and agitating the solid and removing cracks in the filter cake during drying, among other functions. The agitator assembly can also be used to facilitate discharge of the filtered solids.

To accomplish these tasks, the agitator assembly can comprise impellers specifically designed for a certain function such as agitating the filter medium, filtering, washing, and drying, or can comprise multifunctional impellers adapted to perform the functions described herein. For instance, the agitator assembly can comprise two arms with angled blades that rotate in one direction to re-slurry the cake during washing and discharge it at end of cycle. The impellers can smoothen the cake by rotating in one direction and convey the cake for discharge towards the solids discharge port by rotating in the opposite direction. In some aspects, the impeller has no predetermined direction of rotation and is vertically movable to perform the various functions described herein. In some aspects, the impeller comprises blades at a 45° angle relative to the shaft of the agitator assembly.

The agitator assembly and/or the rotating impellers of the agitator assembly can be movable along a longitudinal axis extending from the vessel lid to the vessel body and can be raised or lowered to optimally position the impeller in the crystallizer during a specific function. The agitator assembly and/or the rotating impellers of the agitator assembly can be raised and lowered manually or using mechanisms such as hydraulic systems and servo motors. Manually raising and lowering the impeller can further comprise securing the impeller at any location along the longitudinal axis in the vessel or at discreet positions using notches and the like. Lowering and raising the impeller can be used to adjust the mixing regime required for a reaction, which can be very different from a mixing regime used for a slurry or during redissolution. In an aspect where a reaction generates a slurry or cake, the CFWD impeller can initially be raised to a position further from the base plate and then can be lowered as the slurry/cake is generated to aid in washing and redissolution of the cake, and further repositioned during a drying step to close cracks and compress the cake to reduce residual moisture level. Further reduction in cake moisture can be obtained by slowly rotating and lowering the paddle arms to scrape and de-lump the cake, and to convey the cake for discharge towards the solids discharge port.

(e) Ports

In addition to the solids discharge port, the filtrate outlet, and the mixing port (if present) described above, the CFWD further comprises two or more ports in the vessel of the CFWD device in fluid communication with the process chamber of the CFWD device for inserting tubing for material input and output, as well as for attaching sensors, filters, connectors, probes, samplers, or other devices. Devices include, but are not limited to a filter, a connector, a probe, a sensor, a sampler, and other devices described in Section I(e). The ports can be located anywhere in the crystallizer. The incorporation of various ports into the body of the CFWD allows for gas flow in and out of the crystallizer, as well as fluid flow in and out of the crystallizer. For instance, ports can accommodate headspace gas in, headspace gas out, sparge gas in, reactants and solvents in, catalyst in, culture media in, titrant in, inoculum in, nutrient feeds in, harvest out. It will be understood that the tubing and sensors can be connected to the ports by using any desirable connection technology capable of providing a seal at the port. For instance, ports can comprise industry standard thread sizes that can be used for attaching various components and tubing to the CFWD. Non-limiting examples of industry standard thread sizes are the American National Standard Pipe Thread standard, British Standard Pipe threads, ISO 7-1, 7-2, 228-1, and 228-2 threads, among others. In some aspects, the ports comprise national pipe standards screw threads. They include both tapered and straight thread series for various purposes, including rigidity, pressure-tight sealing, or both. The types are named with a symbol and a full name. Examples of the symbols include NPT (national pipe taper), NPS (National pipe straight), NPSI (National pipe straight—intermediate), NPSC (National pipe straight—coupling), NPSL (National pipe straight—locknut), and NPSM (National pipe straight—mechanical), among others. In some aspects, the ports comprise Female National Pipe Taper (FNPT).

The one or more ports comprise at least one material input port through which reaction material can be introduced to the reaction chamber, and at least one pressure input port for use during drying. The input port can comprise tubing inserted through ports into the reaction medium, or into the headspace of the crystallizer.

(f) Other Components

As described above, the CFWD device of the instant invention can further comprise sensors, filters, connectors, probes, samplers, or connectors for attaching the CFWD device to additional devices or systems. In some aspects, the CFWD device comprises connectors for attaching the CFWD device to a miniature chemical or pharmaceutical manufacturing unit, a pharmaceutical on demand (POD) unit, or a portable formulating apparatus.

Non-limiting examples of sensors that may be used in conjunction with CFWD devices of the instant invention include sensors for fluid flow, temperature, pH, oxygen, pressure, concentration, and sensors that can detect specific compounds in a reaction medium. Fluid flow sensors can sense the rate of reagent or solvent addition which can be adjusted in an adaptive response to real time, or near real time, touchless measurements. Other devices can include pressure relief or other valves such as rupture disks, connectors such as Luer connectors, compression fittings, quick disconnects, aseptic G sterile connectors and other such fitting that would allow for the creation of sterile connections, septums for sampling, filters, bearings such as agitator shaft bearings and bearing assemblies, viewports, and probe ports. CFWD devices of the instant invention can also comprise devices such as light emitting diodes (LEDs) that direct specific electromagnetic energy at a specific wavelength into the crystallizer portion to participate in the reaction process. Such devices can direct the energy through portions in the vessel made of translucent/transparent material. Alternatively, electromagnetic energy devices can be embedded into the side walls of the vessel.

The CFWD device can further comprise contact or contactless measuring systems, which may comprise instruments operable to measure, for example, quantity (i.e., volume, weight, etc.), analyte identity and/or concentration, flow rate, temperature, pressure, turbidly, color, reagent use, reagent verification, and product verification. The measurement of the reactants or reaction in the process chamber may be performed using spectroscopic analysis, ultrasonic detection, or optical detection. Reagent verification, product verification, analyte identity and concentration analysis within the process chamber may be performed using a range of analytical instruments, such as liquid chromatography (LC), high performance liquid chromatography (HPLC) with or without UV-VIS, UV-VIS-DAD, and/or mass spectrometry (MS) detectors, electromagnetic radiation spectroscopy, such as UV/Vis NIRF, FTIR, and RAMAN, and combinations thereof.

The crystallizer can further comprise measuring devices for tracking fluid volume and/or flow rate within the crystallizer using ultrasound or camera and machine vision. Ultrasonic fluid level measurement may be performed, for example, using GL Sciences Liquid Level Sensor Reservoir Accessories. Non-limiting examples of suitable ultrasonic flow rate sensors include SonoFlow® C0.55|Ultrasonic Clamp-On. Liquid volume and flow rate tracking may also be monitored using computer vision and pre-trained instance segmentation computer neural network (CNN). Using this method, the current volume in a transparent CFWD device using a contactless measurement system may be monitored by computer vision based on the pixel area of liquid to vessel. Computer vision may be used to track the fill line of the liquid contents of a transparent or translucent CFWD device.

In some aspects, the temperature in the CFWD device may be monitored using a touchless temperature sensor. Non-limiting examples of suitable touchless temperature sensors include infrared temperature sensors. Exemplary commercially available temperature sensors include Melexis Technologies NV part number MLX90614KSF-ACC-000-TU-ND.

In some aspects, washing efficiency may be further improved if air or gas are not allowed to enter the cake in a multi-washing system. This can be achieved using a liquid/moisture level detector that monitors the surface of the cake for moisture. Further, moisture sensors can be used to determine the moisture content of the solids.

A CFWD device can also comprise a temperature control device operable to control the temperature of the reaction medium. The temperature control device can control temperature by conductive, thermoelectric, resistance heating, impedance, temperature modulation using induction, microwave dielectric heating, and any combination thereof. Non-limiting examples of a temperature control devices include heat exchanger plates or other heating elements on the exterior of the CFWD device, heating elements in the reaction space, and jackets surrounding the CFWD device and/or vessel adapted to regulate the temperature of the reaction medium by providing sources of heating and cooling. In some aspects, the temperature control device is an induction coil, an induction coil support in the vessel base, and a thermistor in the vessel base. In some aspects, the temperature control device is a copper induction coil, an induction coil support in the vessel base, or a Hastelloy™ C276 thermistor in the vessel base.

In some aspects, the agitator comprises controllers for adjusting the speed of agitation and vertical movement of the shaft and impeller to accommodate various reaction conditions, crystallizer configurations, and CPFW functions. Non-limiting examples of means for controlling the speed of mixing include adjusting the speed of rotation of an impeller or magnetic stirrer using a variable speed driver. The variable speed driver can be an adjustable frequency AC controller, a DC motor and drive, a steam turbine driver, or a hydraulic variable speed drive unit (“fluid drive”).

The CFWD device can further comprise a controller in functional communication with components of the device such as the agitator assembly, valves, and sensors, and is operable to provide tight control of the operational sequence of the process on parameters such as temperature and pH. For instance, in some aspects, a controller can perform one or more of the following functions: allow switching on or off components of the system such as a fluid discharge valve, reaction medium inlet valve, agitator assembly, provide controls for system function such as agitator speed, system for raising and lowering of an impeller, and provide monitoring information using data collected by the sensors. The controller can include additional input and output components that permit input by a user (e.g., a touch screen display, a keyboard, a keypad, a mouse, a button, a switch, a microphone, etc.). The controller can also include output components that provide output information (e.g., a display, a speaker, one or more light-emitting diodes (LEDs), etc.).

In addition to the controller, the device can further comprise at least one processor and associated memory adapted to receive the operational and sensor data from the controller. The processor and associated memory can be hard wired to the system or can be networked in a wired or wireless manner. The processor and associated memory can also communicate with a server or other remote computing device in order to execute specific steps. A non-transitory computer readable medium programmed to execute the methods can be loaded on the processor and associated memory or in communication with the system. In some aspects, the processor can be operable to assign one or more event times, wherein each event time indicates the time of a change in the state of a signal received from a component of the system or a sensor. In this aspect, the associated memory can be operable to receive and store the signals and/or outputs of the sensors of the device, and the one or more event times. The storage component may store information and/or software related to the operation and use of the controller. The storage component can include a random-access memory (RAM), a read only memory (ROM), and/or another type of dynamic or static storage device (e.g., a flash memory, a magnetic memory, an optical memory, etc.) that stores information and/or instructions for use by the controller.

In some aspects, it is contemplated that the processor can comprise an alarm system that can be activated in response to one or more inputs from a sensor. In these aspects, it is contemplated that the alarm system can comprise a conventional device for selectively generating optical, thermal, vibrational, and/or audible alarm signals.

In some aspects, when the CFWD is attached to and used in conjunction with a POD unit operable for production of a pharmaceutical, the controller can be adapted to communicate data with at least one processor and associated memory of the POD unit. For instance, the controller can be operable to communicate a signal to the processor and memory of the POD unit in response to sensor data indicating moisture level in the filter cake. In such instance, the POD unit can switch off the pressure and/or vacuum input in response to a signal received from the treatment system controller, indicating a desired moisture level is reached.

(g) Aspects of CFWD Devices

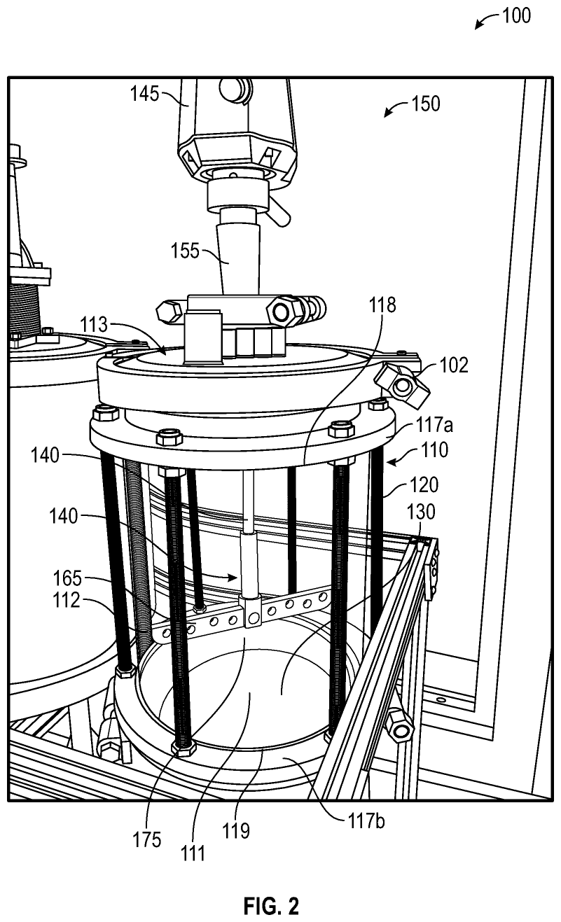

An aspect of a CFWD device 100 is shown in FIGS. 1-3 and 7. The CFWD device 100 comprises a vessel 110 defining a vessel process chamber 111 that can accommodate a reaction medium (not shown). The vessel 110 comprises vessel walls 112, a vessel opening 185, a vessel lid 113, a filter plate 130 (shown in FIGS. 1, 3, and 7), a vessel base 160, and a drain port 115. The vessel walls 112 are shown attached to the vessel lid 113 at the top end 118 of the vessel walls 112. The vessel walls 112 are also shown attached to the vessel base 160 at the bottom end 119 of the vessel walls 112. An agitator motor 145 and flexible coupling 155 are shown. In FIGS. 1, 2, and 7, the motor 145 is shown attached to an agitator shaft distal end 175 of the agitator shaft 140 and is operable to rotate the agitator shaft 140 about its longitudinal axis 180 (shown in FIG. 1). Shown in FIGS. 2, 3, and 7, the vessel lid 113 and the vessel base 160 are removably sealed to the vessel walls 112 using tri-clamp fittings 102. The vessel lid 113 comprises ports.

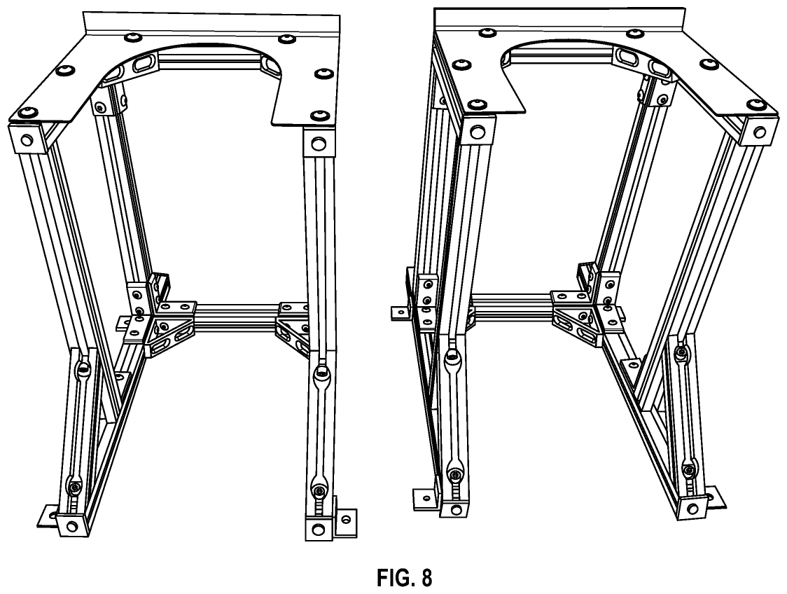

The vessel walls 112 of the vessel 110 in FIGS. 2 and 7 are a tri-clamp sight glass spool. The vessel walls 112 further comprise a sealing rim 117a attached at the top end 118 of the vessel walls 112 and a sealing rim 117b attached to the bottom end 119 of the vessel walls 112 using nut and bolt fitting 120 extending from sealing rim 117a to sealing rim 117b. The tri-clamp fittings 102 attach to the sealing rims 117a and 117b and the vessel lid 113 and vessel base (not shown), respectively, to seal the vessel lid 113 and the vessel base (not shown) to the vessel walls 112. The agitator shaft 140 can be seen extending into the process chamber 111 and the impeller 165 attached at the agitator shaft distal end 175 in the process chamber 111.

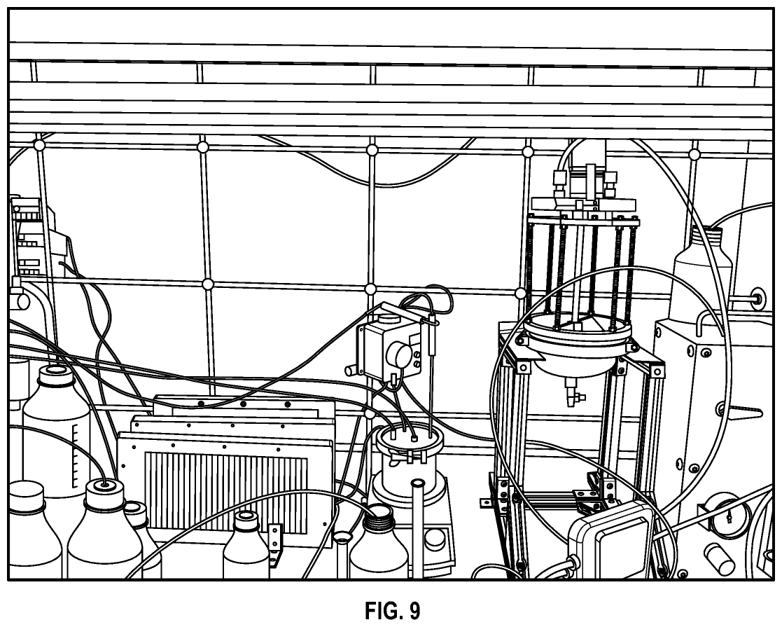

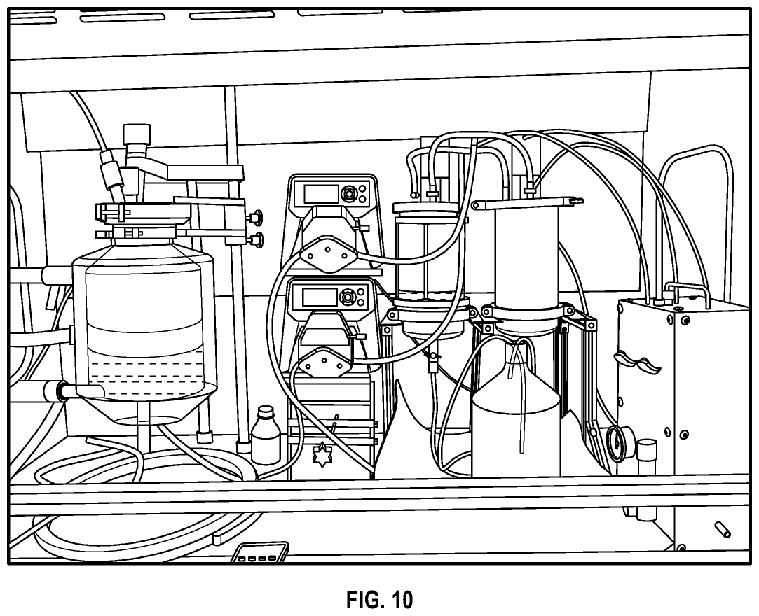

In FIG. 7, a tri-clamp fittings 102 is used to support the CFWD device 100 on a stand 101 (an aspect of which is also shown in FIG. 8) or attach the CFWD device 100 to a miniature chemical or pharmaceutical manufacturing unit, a pharmaceutical on demand (POD) unit, or a portable formulating device, or components thereof (not shown). FIGS. 9 and 10 show two aspect of a CFWD device connected to ancillary components such as fluidic connections vessels, and such, for use in a pharmaceutical manufacturing process.

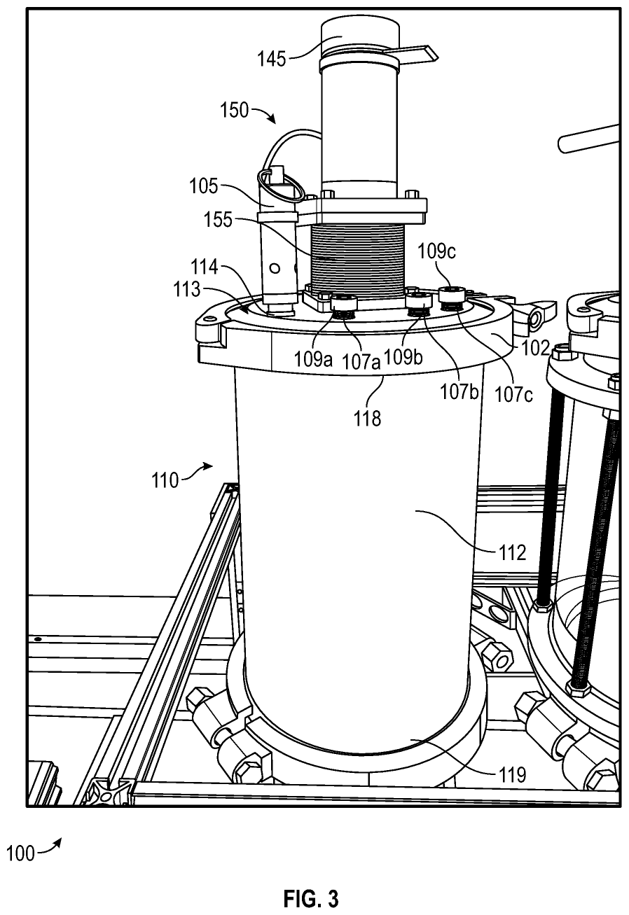

FIGS. 1 and 3 show a vessel lid 113 comprising ports. The vessel lid 113 comprises FNPT ports 107a, 107b, and 107c in the vessel lid 113. The FNPT ports 107a, 107b, and 107c are shown with PFA fittings 109a, 109b, and 109c attached thereto, respectively. In FIG. 3, the vessel lid 113 also comprises a pressure release port 114, a pressure release valve 105 attached to the vessel lid 113 at the pressure release port 114.

FIGS. 1, 2, and 7 show an agitator assembly 150 attached to the lid 113. The agitator assembly 150 comprises an agitator shaft 140 comprising an agitator shaft distal end 175. The agitator assembly 150 further comprises an impeller 165 attached at the agitator shaft distal end 175. The agitator shaft 140 extends through the mixing port 106 (shown in FIG. 1) in the vessel lid 113.

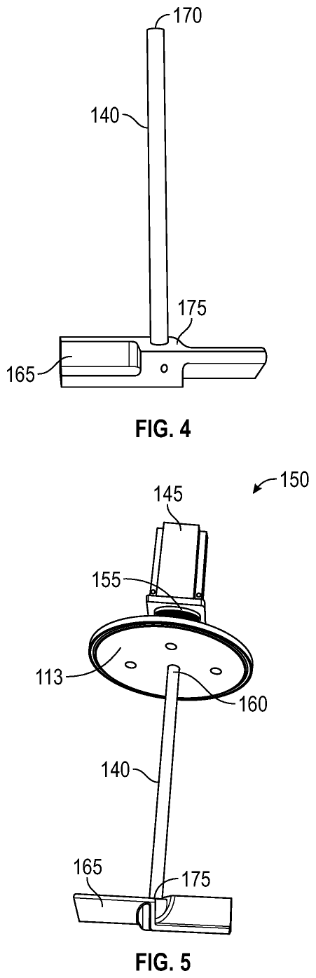

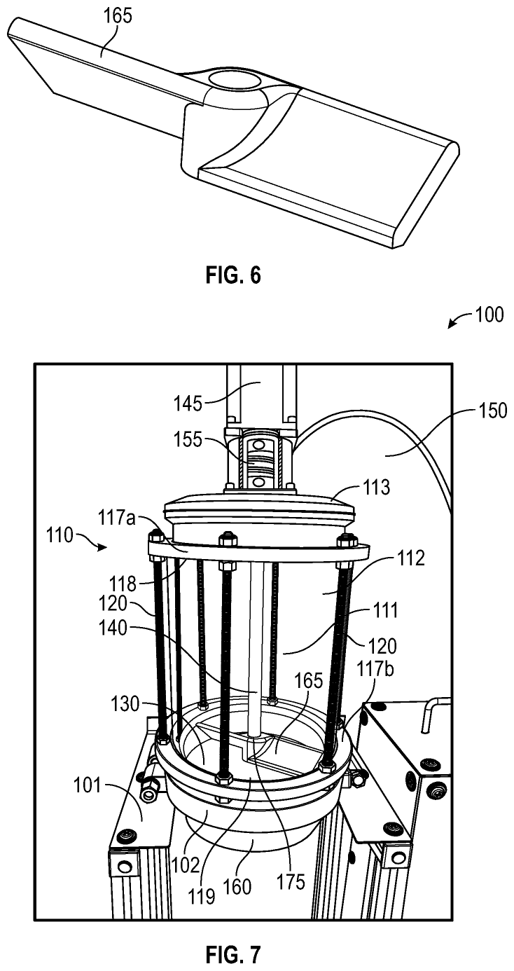

FIG. 5 shows the agitator assembly 150 of the CFWD device 100 (not shown). The agitator assembly comprises a shaft 140 extending through the mixing port 106 in the lid 113. The agitator assembly 150 further comprises an impeller 165 attached at the agitator shaft distal end 175. The agitator motor 145 is attached to the shaft 140 through a flexible coupling 155 and is operable to rotate the agitator shaft 140. FIG. 4 shows the agitator shaft 140 comprising a proximal end 170 (also shown in FIG. 1), a distal end 175, and an impeller 165 attached at the agitator shaft distal end 175. FIG. 6 shows an aspect of an impeller 165 architecture.

### II. Methods

Another aspect of the present invention encompasses a method of producing a crystalline form of a compound of interest in an operational sequence of a process for manufacturing a crystal form of a compound of interest. The method comprises introducing one or more solutions comprising the compound of interest into the process chamber and using the crystallizer function of the CFWD device to produce the crystalline compound (See Section II(a) herein below). The CFWD device can also function as a reactor (See Section II(b) herein below) to carry out any chemical or biological reaction or fermentation in a reaction medium to generate the product of interest for crystallization. Optionally, the resultant crystals can then be filtered, washed, dried or any combination thereof using the filter, washer, dryer functions of the CFWD device of the instant invention. The CFWD can be as described in Section I herein above.

In some aspects, the method comprises producing the crystalline compound, followed by filtering, washing, and drying the crystalline compound. During filtration, the slurry comprising the crystalline compound is filtered through the filter plate resulting in a filter cake on the filter plate comprising the solid phase crystals. During a filtering step, the agitator assembly can be used to keep the crystal product in suspension during filtration. Keeping the slurry in suspension during the filtering step can assist in forming a homogeneous filter cake. The liquid phase of the slurry can be discarded, recycled for reuse in a similar or different process, or can continue to other equipment for further processing if the liquid phase comprises a desired material of the chemical process.

To wash the filtered crystals in the filter cake, a wash liquid is introduced into the vessel chamber and pressure and/or vacuum is applied. This displaces any remaining mother liquor in the filter cake with the wash liquid. This is sometimes referred to as cake washing or displacement washing. One of the advantages of the CFWD is the ability to use the agitator assembly to smooth the cake's surface and eliminate mounding or cracking of the filter prior to applying spray wash for even washing of the entire bed (See Section I(d) herein above). As an additional washing option, a re-slurry washing (also known as cake repulping) can be performed if additional extraction or dissolving of impurities is necessary. The re-slurry process can also be used when a long contact time is needed between the wash fluid and the solids or crystals, or the displacement wash does not provide the required wash quality. The re-slurry process can comprise resuspending the cake in wash fluid with the impeller of the agitator assembly for thorough mixing with the wash solution. Each of the washing steps can be repeated once, twice, three times, or as many times as is necessary to obtain the desired purity of the solids.

The crystalline compound can then be dried using vacuum, pressure drying, convection drying, or any combination thereof. During the drying step, the agitator can be used to close cracks and compress the cake to reduce residual moisture level. This function helps to achieve uniform flow of liquid or gas through the filter cake, while helping to eliminate liquid and gas channeling that reduces the efficiency of displacement washing and gas blow through. Further reduction in cake moisture can be obtained by slowly rotating and lowering the paddle arms to scrape and de-lump the cake.

The choice of a drying method depends on the behavior of the crystals during drying. Vacuum and pressure drying, the most common drying methods used, involve the application of a vacuum or pressure source and agitation to draw or push the liquid phase through the filter plate. The agitation can be provided using the agitator assembly of the device. During convection drying, hot, pressurized gas is blown through the crystals and out of the filtrate outlet, eventually drying the solids. Unlike vacuum or pressure drying, convection drying does not require agitation. Non-limiting examples of gas include air or inert gases such as nitrogen, carbon dioxide, argon, helium, or any combination thereof.

The degree to which a crystalline compound is dried can and will vary depending on the particular process being performed by the CFWD. For instance, the crystalline compound can be dried to yield a solid comprising less than 0.01%, 0.05%, 0.1%, 0.5%, 1%, 5%, 10%, 20%, 30%, 40%, 50%, 60%, 70%, 80%, 90%, or 99% final product moisture, or any % moisture within these ranges. The temperature and period of time used to dry a crystalline compound can and will vary depending on the crystalline compound and the level of humidity of the crystalline compound, among other variables, and can be determined experimentally.

The final step in a process can be the discharge of the dried crystalline compound. This step can be accomplished through the vessel opening or through a solids discharge port of the CFWD device. The agitator can be used to facilitate discharge of the crystalline compound. For instance, when a solids discharge port is on a side of the vessel, the agitator is slowly lowered as it rotates, effectively moving the crystalline compound to the solids discharge port on the side of the vessel or in the vessel base. There are certain applications where the desired product to be discharged is not a dry crystalline compound. The impellers can be designed to facilitate flexible discharge, which allows for wet solids, slurries, or even liquid to be discharged. The crystalline compound can also be collected by removing the vessel lid or base to access the filter cake. In some aspects, the process can further comprise the step of backwashing the filter plate with a wash liquid to dislodge and remove any residue of solids that adhered to the medium after cake discharge.

The one or more of the solutions introduced into the CFWD device can be a product of a chemical reaction conducted in a second reactor fluidically connected with the CFWD device. Further, the CFWD device can be fluidically connected with other modules fluidically connected with the CFWD device, wherein the modules perform the same or different chemical processes to produce chemical products. Some aspects comprise transporting a fluid (e.g., a chemical reagent, a solvent, or combinations thereof) through the one or more modules fluidically connected in series or in parallel, or combinations thereof. Some aspects comprise transporting a first fluid (e.g., a chemical reagent, a solvent, or combinations thereof) through a first module and a second module fluidically connected to the first module to form a first chemical product (which is output from the second module).

Continuous processes generally refer to systems in which precursor entering the system, product exiting the system, and the transformation the system is designed to achieve, all occur during at least a portion of the time during which the transformation occurs. As one example, a solid reaction product is harvested, and the liquid fraction of the slurry exits the CFWD device during at least a portion of the time that the chemical reaction within the CFWD device is taking place.

Continuous systems that include two or more CFWD devices of the present invention connected with other devices used in a process for producing a chemical product can be arranged such that transport between the modules within the continuous system occurs during at least a portion of the time during which the modules are performing their intended function (e.g., reaction for a reactor, filtering for an CFWD, etc.).

In some aspects, a chemical product is produced continuously from one or more precursors of the chemical product when precursors of the chemical product are being transported into the continuous system and chemical product is being transported out of the continuous system, during at least portions of the times the components of the continuous system are being operated to produce the finished chemical product. In a process comprising use of an CFWD, the solid chemical product is produced and continuously filtered.

In some aspects, the CFWD device of the present invention is used in connection with miniature chemical or pharmaceutical manufacturing units, pharmaceutical on demand (POD) units. POD units are comprised of a number of individual production modules that interact with one another in order to perform one or more steps in a chemical production process. In some aspects, the POD units are sufficiently small such that they are suitable for manufacturing pharmaceuticals or finished drug products which are to be directly distributed and/or deployed to pharmacies, hospitals and to consumers, rather than depend on pharmaceuticals from a large manufacturing plant.

In some aspects, the fluid transported into the CFWD device of the present invention, as described above, comprises a solvent. Solvents can be aprotic solvents, protic solvents, organic solvents, and any combination thereof. Non-limiting examples of suitable aprotic solvents include acetone, acetonitrile, diethoxymethane, N,N-dimethylformamide (DMF), dimethyl sulfoxide (DMSO), N,N-dimethylpropionamide, 1,3-dimethyl-3,4,5,6-tetrahydro-2(1H)-pyrimidinone (DMPU), 1,3-dimethyl-2-imidazolidinone (DMI), 1,2-dimethoxyethane (DME), dimethoxymethane, bis(2-methoxyethyl)ether, N,N-dimethylacetamide (DMAC), 1,4-dioxane, N-methyl-2-pyrrolidinone (NMP), ethyl acetate, ethyl formate, ethyl methyl ketone, formamide, hexachloroacetone, hexamethylphosphoramide, methyl acetate, N-methylacetamide, N-methylformamide, methylene chloride, nitrobenzene, nitromethane, propionitrile, sulfolane, tetramethylurea, tetrahydrofuran (THF), 2-methyl tetrahydrofuran, trichloromethane, and combinations thereof. Suitable examples of protic solvents include, but are not limited to, methanol, ethanol, isopropanol, n-propanol, isobutanol, n-butanol, s-butanol, t-butanol, formic acid, acetic acid, water, and combinations thereof. Suitable organic solvents include, but are not limited to, alkane and substituted alkane solvents (including cycloalkanes), aromatic hydrocarbons, esters, ethers, ketones, combinations thereof, and the like and any combination thereof. Organic solvents that may be employed include, for example, acetonitrile, benzene, butyl acetate, t-butyl methylether, t-butyl methylketone, chlorobenzene, chloroform, chloromethane, cyclohexane, dichloromethane, dichloroethane, diethyl ether, ethyl acetate, diethylene glycol, fluorobenzene, heptane, hexane, isobutylmethylketone, isopropyl acetate, methylethylketone, 2-methyltetrahydrofuran, pentyl acetate, n-propyl acetate, tetrahydrofuran, toluene, and any combination thereof.

It will be understood by those of ordinary skill in the art that the CFWD devices of the present invention can be used to synthesize an API, or precursors or intermediates thereof. As used herein, the term “API” or “active pharmaceutical ingredient” (also referred to as a “drug”) refers to an agent that is administered to a subject to treat a disease, disorder, or other clinically recognized condition, or for prophylactic purposes, and has a clinically significant effect on the body of the subject to treat and/or prevent the disease, disorder, or condition. Active pharmaceutical ingredients include, for example, without limitation, agents listed in the United States Pharmacopeia (USP). In some aspects, the active pharmaceutical ingredient is one that has already been deemed safe and effective for use in humans or animals by the appropriate governmental agency or regulatory body. For example, drugs approved for human use are listed by the FDA under 21 C.F.R. §§ 330.5, 331 through 361, and 440 through 460, incorporated herein by reference; drugs for veterinary use are listed by the FDA under 21 C.F.R. §§ 500 through 589, incorporated herein by reference. All listed drugs are considered acceptable for use in accordance with the present invention.

In certain aspects, the active pharmaceutical ingredient is a small molecule. Exemplary active pharmaceutical ingredients include, but are not limited to, adrenergic blocking agents, anabolic agents, androgenic steroids, antacids, anti-asthmatic agents, anti-allergenic materials, anti-cholesterolemic and anti-lipid agents, anti-cholinergics and sympathomimetics, anti-coagulants, anti-convulsants, anti-diarrheal, anti-emetics, anti-hypertensive agents, anti-infective agents, anti-inflammatory agents such as steroids, non-steroidal anti-inflammatory agents, antimalarials, anti-manic agents, anti-nauseants, anti-neoplastic agents, anti-obesity agents, anti-parkinsonian agents, anti-pyretic and analgesic agents, anti-spasmodic agents, anti-thrombotic agents, anti-uricemic agents, anti-anginal agents, antihistamines, anti-tussives, appetite suppressants, benzophenanthridine alkaloids, biologicals, cardioactive agents, cerebral dilators, coronary dilators, decongestants, diuretics, diagnostic agents, erythropoietic agents, estrogens, expectorants, gastrointestinal sedatives, agents, hyperglycemic agents, hypnotics, hypoglycemic agents, ion exchange resins, laxatives, mineral supplements, mitotics, mucolytic agents, growth factors, neuromuscular drugs, nutritional substances, peripheral vasodilators, progestin agents, prostaglandins, psychic energizers, psychotropics, sedatives, stimulants, thyroid and anti-thyroid agents, tranquilizers, uterine relaxants, vitamins, antigenic materials, and prodrugs, etc. Non-limiting examples of APIs include propofol, midazolam, cisatracurium, ciprofloxacin, and others.

As used herein, the term “small molecule” refers to molecules, whether naturally occurring or artificially created (e.g., via chemical synthesis) that have a relatively low molecular weight. Typically, a small molecule is an organic compound (i.e., it contains carbon). The small molecule may contain multiple carbon-carbon bonds, stereocenters, and other functional groups (e.g., amines, hydroxyls, carbonyls, and heterocyclic rings, etc.). In certain aspects, the molecular weight of a small molecule is at most about 1,000 g/mol, at most about 900 g/mol, at most about 800 g/mol, at most about 700 g/mol, at most about 600 g/mol, at most about 500 g/mol, at most about 400 g/mol, at most about 300 g/mol, at most about 200 g/mol, or at most about 100 g/mol. In certain aspects, the molecular weight of a small molecule is at least about 100 g/mol, at least about 200 g/mol, at least about 300 g/mol, at least about 400 g/mol, at least about 500 g/mol, at least about 600 g/mol, at least about 700 g/mol, at least about 800 g/mol, or at least about 900 g/mol, or at least about 1,000 g/mol. Combinations of the above ranges (e.g., at least about 200 g/mol and at most about 500 g/mol) are also possible.

Also as noted above, the CFWD device can be used with modular systems, and the methods described herein can be used to produce ingestible pharmaceutical compositions. Generally, ingestible pharmaceutical compositions refer to those compositions including an active pharmaceutical ingredient and a pharmaceutically acceptable excipient. As used herein, the term “pharmaceutically acceptable excipient” means a non-toxic, inert solid, semi-solid or liquid filler, diluent, encapsulating material, or formulation auxiliary of any type. Some non-limiting examples of materials which can serve as pharmaceutically acceptable excipients are sugars such as lactose, glucose, and sucrose; starches such as corn starch and potato starch; cellulose and its derivatives such as sodium carboxymethyl cellulose, methylcellulose, hydroxypropylmethylcellulose, ethyl cellulose, and cellulose acetate; powdered tragacanth; malt; gelatin; talc; excipients such as cocoa butter and suppository waxes; oils such as peanut oil, cottonseed oil; safflower oil; sesame oil; olive oil; corn oil and soybean oil; glycols such as propylene glycol; esters such as ethyl oleate and ethyl laurate; agar; detergents such as Tween 80; buffering agents such as magnesium hydroxide and aluminum hydroxide; alginic acid; water (e.g., pyrogen free water); isotonic saline; citric acid, acetate salts, Ringer's solution; ethyl alcohol; and phosphate buffer solutions, as well as other non-toxic compatible lubricants such as sodium lauryl sulfate and magnesium stearate, as well as coloring agents, releasing agents, coating agents, sweetening, flavoring and perfuming agents, preservatives and antioxidants can also be present in the composition, according to the judgment of the formulator.

The CFWD device can also be used with modular systems and the methods described herein to produce pharmaceutical compositions for parenteral administration (including subcutaneous, intradermal, intravenous, intramuscular, and intraperitoneal). Formulations for parenteral administration can be an aqueous or an oil-based solution. Aqueous solutions may include a sterile diluent such as water, saline solution, a pharmaceutically acceptable polyol such as glycerol, propylene glycol, or other synthetic solvents; an antibacterial and/or antifungal agent such as benzyl alcohol, methyl paraben, chlorobutanol, phenol, thimerosal, and the like; an antioxidant such as ascorbic acid or sodium bisulfite; a chelating agent such as etheylenediaminetetraacetic acid; a buffer such as acetate, citrate, or phosphate; and/or an agent for the adjustment of tonicity such as sodium chloride, dextrose, or a polyalcohol such as mannitol or sorbitol. The pH of the aqueous solution may be adjusted with acids or bases such as hydrochloric acid or sodium hydroxide. Oil-based solutions or suspensions may further comprise sesame, peanut, olive oil, or mineral oil.

For topical (e.g., transdermal or transmucosal) administration, penetrants appropriate to the barrier to be permeated are generally included in the preparation. Transmucosal administration may be accomplished through the use of nasal sprays, aerosol sprays, tablets, or suppositories, and transdermal administration may be via ointments, salves, gels, patches, or creams as generally known in the art.

### (a) Crystallization

Crystallization can be initiated by subjecting a solution of a compound of interest to conditions suitable for the generation of a supersaturated solution of the compound, thereby inducing nucleation and growth of the crystalline form of the compound of interest in the supersaturated solution. Supersaturation occurs with a chemical solution when the concentration of a solute exceeds the concentration specified by the value equilibrium solubility. A supersaturated solution is in a metastable state; it may be brought to equilibrium by forcing the excess of solute to separate from the solution. The term can also be applied to a mixture of gases.

Conditions suitable for generating supersaturation are known in the art and include, without limitations, cooling, evaporation, reaction, drowning out, salting out, or any combination thereof. Cooling can be achieved using the vessel walls, internal coils, or by pumping the supersaturated solution through an external heat exchanger. Cooling conditions are used when solubility changes significantly with temperature and when the feed stream is near saturation at a high temperature. Evaporation can be achieved by heating the supersaturated solution or reducing the pressure in the headspace in the process camber to form a boiling zone. Reaction conditions comprise introducing feed streams into the process chamber to form a reaction medium and subjecting the reaction medium to conditions to cause an intended reaction generating the compound of interest, usually at high levels of supersaturation. Drowning out can be achieved by adding a miscible solvent to a solution of the compound of interest resulting in a mixture in which the product is less soluble. Salting out comprises adding a salt with a common ion to precipitate the product from solution. It should be noted that the compound can also be in gaseous form, and the compound is crystallized from a gas.

Conditions prevailing during crystallization can be judiciously selected, controlled, and/or maintained, to encourage the production crystals of the compound of interest that meet quality specifications such as size, shape, composition, and internal structure. In general, conditions can be varied to control the rate of generation of supersaturation, the rate of nucleation, and the rate of crystal growth. For instance, for the production of large crystals, the overall strategy can comprise forming relatively few nuclei followed by growing the nuclei to product size under conditions which minimize further nuclei formation.

Accordingly, a method of the instant invention comprises introducing one or more solutions comprising the compound of interest into the process chamber of the CFWD device or kit comprising the CFWD or introducing one or more reagents into the CFWD process chamber to produce the compound of interest in the process chamber (See Section II(b) herein below). The method further comprises operating the CFWD device or kit comprising the CFWD, to subject the contents of the process chamber to the supersaturating conditions to induce nucleation and growth of the crystalline form of the compound of interest in the supersaturated solution. A method can further comprise selecting, controlling, and/or maintaining conditions prevailing in the process chamber to encourage the production of crystals of the compound of interest that meet quality specifications such as size, shape, composition, and internal structure. If a reaction process is also to be performed, the one or more reagents are subjected to conditions appropriate for completing the reaction in the process chamber. The conditions can be controlled by controlling one or more process parameters (e.g., temperature, pressure, residence time, mixing).

The CFWD can be operated to induce, adjust, and/or maintain one or more crystallization parameters within the process chamber of the CFWD device or a kit comprising the CFWD. For instance, where the CFWD device comprises or is associated with a heating or cooling device, the temperature within the process chamber may be selected, maintained, or adjusted. Where the CFWD device comprises or is associated with a pressure adjusting device (e.g., a vacuum pump or autoclave), the pressure (or lack thereof) within the process chamber may be selected, maintained, or adjusted. Where the CFWD device or kit comprising the CFWD, is configured to receive input from one or more further input flow lines, prevailing reaction conditions (e.g., pH) in the process chamber may be selected, maintained, or adjusted. Alternatively, where the CFWD device or kit comprising the CFWD, comprises a gas outlet or gas output flow line, optionally connected to a scrubber (e.g., soda lime scrubber for scrubbing excess), gaseous input materials and/or gaseous output materials (produced following the crystallization process) may be conveniently diverted so that an output load carrying output material(s) exiting the CFWD device comprises a reduced concentration of said gaseous materials relative to the concentration of said gaseous materials in the reaction mixture (i.e., within the CFWD device). Alternatively, however, such separation of gases (and optional scrubbing) may occur downstream from the CFWD device or kit comprising the CFWD, suitably at a collector point (where the output load is collected). Such induction, adjustment, and/or maintenance of one or more reaction parameters within the internal CFWD device may suitably further facilitate a chemical reaction within the internal CFWD device.

A CFWD device or kit comprising the CFWD, of the instant invention can be operated in a batch mode, a continuous mode, or combination of batch and continuous modes. When operated in batch mode, the one or more solutions comprising the compound of interest are introduced into the process chamber, the compound is allowed to crystallize before harvesting the crystalline compound at the end of the process. In some aspects, solutions can be added, product can be withdrawn, or a combination thereof during this time. The crystalline product is removed at the end of the batch. Continuous operation of a CFWD device and kit can be achieved by switching between two or more CFWD devices operated in parallel. The CFWDs would operate in a staggered fashion with the process stream from an upstream unit, such as reactor, continuously switching to the next CFWD after a defined length of time. This procedure would allow the upstream process to continuously feed the CFWD kit and ensure that each individual CFWD device would receive a defined volume charge that could then undergo batch operations such as crystallization, deliquoring, washing, offloading, and cleaning before the upstream feed cycles back to that CFWD.

In one aspect, a CFWD or its kit is positioned after a stirred tank reactor or continuous stirred tank reactor, or its kit, in the process flow. The reaction mixture from the reactor is pumped into the CFWD while the agitator is rotating clockwise and anti-solvent is added either simultaneously or subsequently to induce crystallization. The resulting slurry is allowed to age until the crystallization is complete and then N₂ pressure/vacuum is applied to filter the slurry. Near the end of the deliquoring, the direction of agitation is reversed to smooth the filter cake and eliminate any mounding or cracking. Once deliquoring is complete, N₂ pressure/vacuum is removed, and a wash solvent is added. If reslurrying is required for the wash, the direction of agitation is returned to clockwise. Once the wash step is complete, N₂ pressure/vacuum is once again applied to deliquor the wash. Near the end of the deliquoring, the direction of agitation is reversed to smooth the filter cake and eliminate any mounding or cracking and N₂ pressure/vacuum application continues until the filter cake reaches the desired dryness. The resulting filter cake is either offloaded as a solid or dissolved in a suitable solvent and pumped/pressure transferred to the next unit.

### (b) Use as a Reactor

As explained above, the CFWD device can also function as a reactor to carry out any chemical or biological reaction or fermentation in a reaction medium where constant agitation is required. The reaction medium is optionally subjected to reaction conditions to cause an intended reaction between the reagents, and products are continuously removed. The CFWD can function as a batch reactor or a semi-batch reactor. The CFWD can also function as a continuous stirred tank reactor (CSTR), also known as a vat- or backmix reactor, or a mixed flow reactor (MFR). Batch reactors are reactors in which the reactants are added to the reactor at the start of the reaction. The reactants are allowed to react in the reactor for a fixed time. In some aspects, reagent feed can be added, product can be withdrawn, or a combination thereof during this time. The reaction products are removed at the end of the batch. Semi-batch (semiflow) reactors operate much like batch reactors in that they take place in a single stirred tank with similar equipment. However, they are modified to allow reactant addition and/or product removal in time. In a CSTR, one or more reagents are continuously introduced into the reactor in a reactor input stream and stirred to ensure proper mixing of the reagents in the reaction medium. CSTRs are run at steady state, and a uniform composition is assumed throughout each reactor.

The reactions that may be conducted in a CFWD using the reactor function of the device may include hydrogenations, polymerizations, synthesis of chemical compounds such as pharmaceuticals, catalytic reactions, petrochemical, crystallization, enzymatic reactions, and nanoparticle synthesis among others. CFWDs can also be used as bioreactors or fermenters to conduct cell culture. Typical non-limiting applications include brewing, pharmaceuticals, wastewater treatment, biologicals, biopharmaceuticals, tissue engineering, microorganisms, plant metabolites, food production, hydrocarbon processing such as in the petrochemical industry, manufacturing in the semiconductor industry, and manufacture of quantum dots, among others.

In some aspects, a method of synthesizing a chemical compound comprises providing or having provided one or more input materials, introducing the one or more input materials into the process chamber of the CFWD in a reactor input stream, and subjecting the one or more input materials in the reactor to conditions to cause a chemical reaction between the input materials. In some aspects, the chemical reaction comprises a solid compound. Reaction media comprising the resulting chemical compound is harvested from the reactor by filtering, washing, and drying the solid chemical compound.

### III. CFWD Modules

An additional aspect of the present invention encompasses a CFWD module or a CFWD device and other components that can be attached or connected to the CFWD device for assembly into CFWD modules suitable for use in a process for synthesizing a compound of interest such as an API or an API precursor. For instance, the CFWD module can comprise the CFWD device, sensors, filters, connectors, probes, samplers, or connectors for attaching the CFWD device to additional devices or systems. Other components can be as described in Section I herein above

The one or more CFWD kits or modules can have different specifications of size and reaction conditions and filter plates of various sizes and capabilities. The kits or modules can be used in a wide variety of processes such as isolation of Cis amide and Cis BAP, Isolation of NCA, Lactam, AFP, and DMPC (both for removal of byproduct and isolation of solid); isolation of DIHA following recrystallization; initial DIHA crystallization; isolation of TCE, TCA, and midazolam; and the Cipro 1-step process.

### DEFINITIONS

Unless otherwise defined herein, scientific and technical terms used in connection with the present invention shall have the meanings that are commonly understood by those of ordinary skill in the art. The meaning and scope of the terms should be clear, however, in the event of any latent ambiguity, definitions provided herein take precedent over any dictionary or extrinsic definition. Further, unless otherwise required by context, singular terms as used herein and in the claims, shall include pluralities and plural terms shall include the singular.

When introducing elements of the present invention or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant, both in relation to the other endpoint, and independently of the other endpoint.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

The terms “crystal,” “crystal phase,” or “crystalline solid” refer to a solid material whose constituents (such as atoms, molecules, or ions) are arranged in a highly ordered microscopic structure, forming a crystal lattice that extends in all directions. In addition, macroscopic single crystals are usually identifiable by their geometrical shape, consisting of flat faces with specific, characteristic orientations. The process of crystal formation via mechanisms of crystal growth is called crystallization or solidification.

Nucleation is the initiation of a phase change in a small region, such as the formation of a solid crystal from a liquid solution. It is a consequence of rapid local fluctuations on a molecular scale in a homogeneous phase that is in a state of metastable equilibrium.

The terms “cake” and “filter cake” are used interchangeably and refer to the bed of solids (insoluble material) deposited on the filter plate after or during filtration of a slurry.

As various changes could be made in the above-described devices and methods without departing from the scope of the invention, it is intended that all matter contained in the above description and in the examples given below, shall be interpreted as illustrative and not in a limiting sense.

### EXAMPLES

All patents and publications mentioned in the specification are indicative of the levels of those skilled in the art to which the present invention pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

The following examples are included to demonstrate the disclosure. It should be appreciated by those of skill in the art that the techniques disclosed in the following examples represent techniques discovered by the inventors to function well in the practice of the disclosure. Those of skill in the art should, however, in light of the present invention, appreciate that many changes could be made in the disclosure and still obtain a like or similar result without departing from the spirit and scope of the disclosure, therefore all matter set forth is to be interpreted as illustrative and not in a limiting sense.

### Example 1. Production of Cis-Amide, an Intermediate in the Manufacture of Cisatracurium in a Pharmaceutical On Demand (POD) Unit

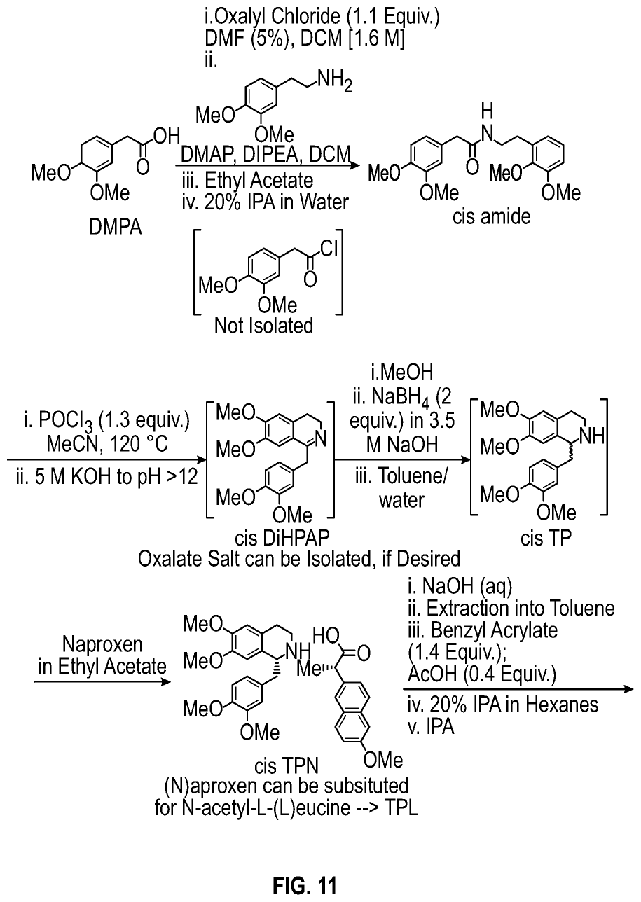

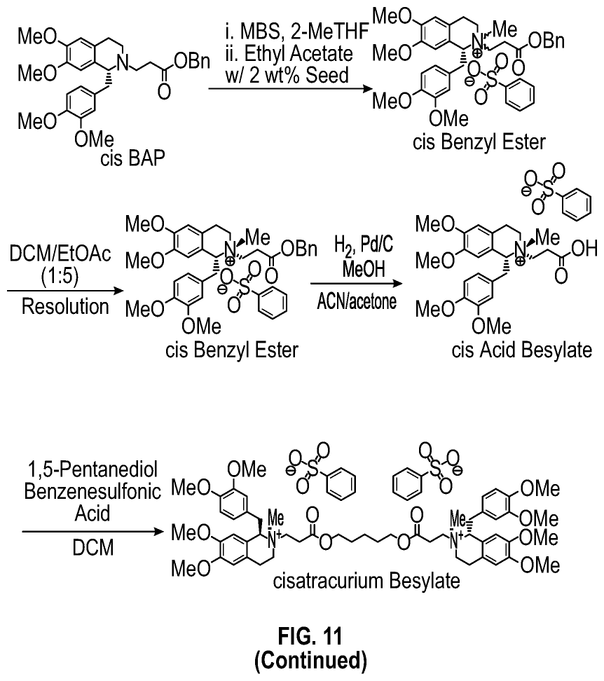

Cis-amide is an intermediate formed during the first step of a chemical process for making cisatracurium besylate depicted schematically in FIG. 11. To prepare cis-amide using the depicted process, homoveratrylamine (562 g, 3.1 moles, 1 equiv.), N,N-diisopropylethylamine (801 g, 6.2 moles, 2 equiv.) and DCM were charged to a glass bottle and stirred until homogeneous. This solution served as the amine feedstock. Isopropanol (1 L) and pentane (4 L) were charged into a bottle. This solution served as the anti-solvent feedstock. The same setup used for the generation of III was used for the synthesis of cis amide. An additional pump was required for the antisolvent, and this solvent was plumbed to the cis amide collection vessel. The reactors were heated to 40° C. and the two feedstocks were pumped into the reactors at a total flow rate of 18 mL/min (9 mL/min for acid chloride feedstock and 9 mL/min for chlorination feedstock) to achieve a residence time of 10 minutes. The first 20 minutes of the continuous run was diverted to waste. Collection was plumbed to a CFWD and the reactor outlet stream and antisolvent feedstock were pumped into the CFWD at an overall flow rate of 36 mL/min. Upon complete consumption of the acid chloride and amine feedstocks, the reactors were flushed with DCM and collection continued for ten minutes. The reactor outlet was diverted to waste and the reactors were flushed for 15 minutes with DCM followed by a 15-minute flush with methanol.

A dense slurry formed in the CFWD and N₂ pressure was applied to deliquor the slurry. The resulting solid was washed with 20% IPA in pentane, filtered, slurried in 20% IPA in water and filtered to afford a pale yellow to white solid (677.1 g, liquid chromatography area percent>98%, 61% yield).

### Example 2. Production of Cis-BAP, an Intermediate in the Manufacture of Cisatracurium in a Pharmaceutical on Demand (POD) Unit

A CFWD device of the instant invention was used to prepare Cis-BAP. Cis-BAP is an intermediate formed during a chemical process for making cisatracurium besylate depicted schematically in FIG. 11. R-tetrahydropapaverine N-acetyl-L-leucinate (496 g), toluene (1.3 L) and 1 M sodium hydroxide (1.5 L) were charged to a glass bottle containing S-arylpropionic salt (VIII) with aqueous base and extracting the neutral R-tetrahydropapaverine into toluene, however another counterion such as (S)-2-(6-methoxynaphthalen-2-yl)propanoic acid could be substituted for N-acetyl-L-leucinate. The mixture was stirred until no solid is observed. The layers were separated by gravity, the organic phase was dried over sodium sulfate and filtered to remove any insoluble material. Typical water content was 3000 ppm. This material served as TP feedstock. A 10% (v/v) acetic acid and benzyl acrylate solution was prepared and served as benzyl acrylate feedstock. A 20% IPA in hexanes solution was prepared and served as antisolvent feedstock.

Two piston pumps, one for each feedstock, were plumbed with PFA tubing (⅛″ OD, 1/16″ ID) and connected to a T-fitting (IDEX, PEEK, 0.050″ bore). The outlet port of the T-fitting was connected inline to the reactors. A 68.4′ length of PFA tubing ( 3/16″ OD, ⅛″ ID) was fitted into three aluminum clam shell reactors (˜300″ tubing for two reactors and ˜224″ tubing for the third reactor) and equipped with heating pads and thermocouples for temperature control and temperature monitoring. The reactor tubing was connected in series using union fittings (IDEX, PEEK, 0.050″ bore). The reactor outlet was plumbed to a back pressure regulator (BPR, 100 psi) with PFA tubing (⅛″ OD, 1/16″ ID) and the BPR outlet was plumbed to a CFWD. A third piston pump for the antisolvent feedstock was plumbed directly to the CFWD.

The TP feedstock (7.53 mL/min) and benzyl acrylate feedstock (0.73 mL/min) were pumped into the reactors at 130° C., at an overall flow rate of 8.26 mL/min to achieve a residence time of 20 minutes. The first 35 minutes of collection was diverted to waste. When collection began, the flow of the antisolvent feedstock was initiated at a flow rate of 24.8 mL/min. The resulting precipitate slurry in the CFWD was stirred, filtered and washed with isopropanol to give benzyl (R)-3-(1-(3,4-dimethoxybenzyl)-6,7-dimethoxy-3,4-dihydroisoquinolin-2(1H)-yl)propanoate (259.2 g, LCAP purity: >98%). A dual CFWD setup would allow for fully continuous production of benzyl (R)-3-(1-(3,4-dimethoxybenzyl)-6,7-dimethoxy-3,4-dihydroisoquinolin-2(1 H)-yl)propanoate.

### Example 3. Use of a CFWD Device in the Manufacture of Midazolam in a Pharmaceutical on Demand (POD) Unit

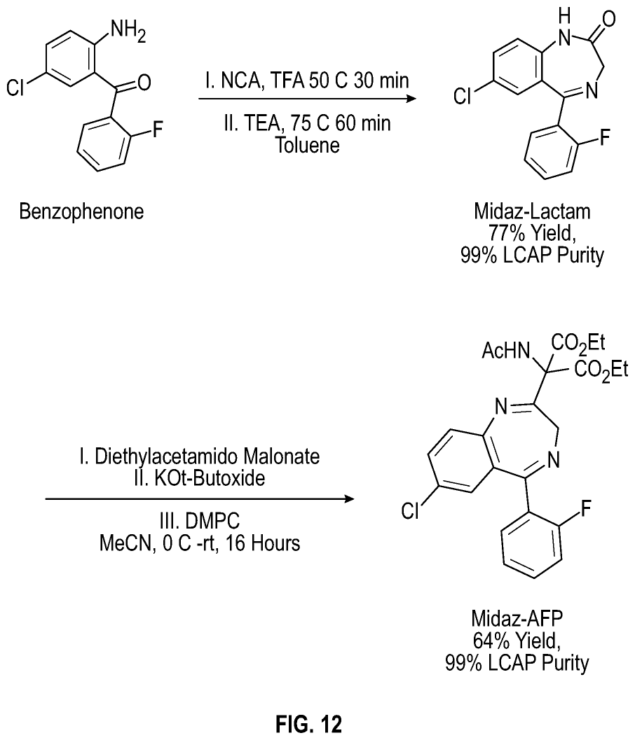

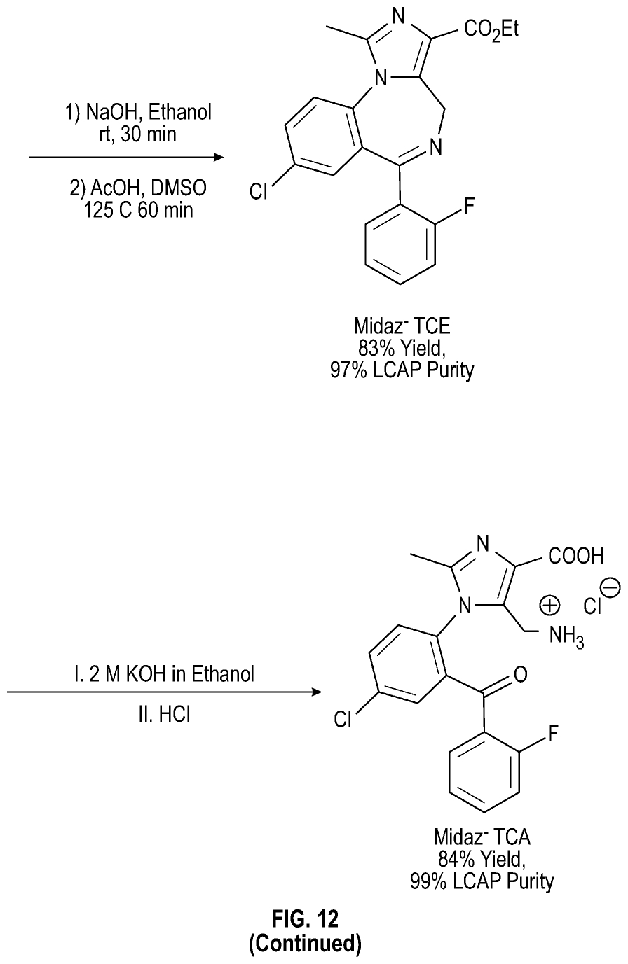

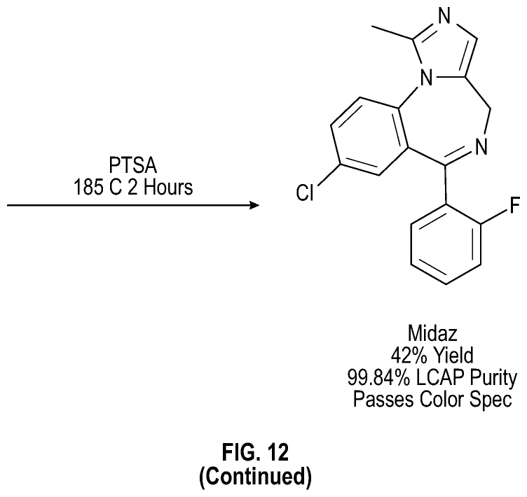

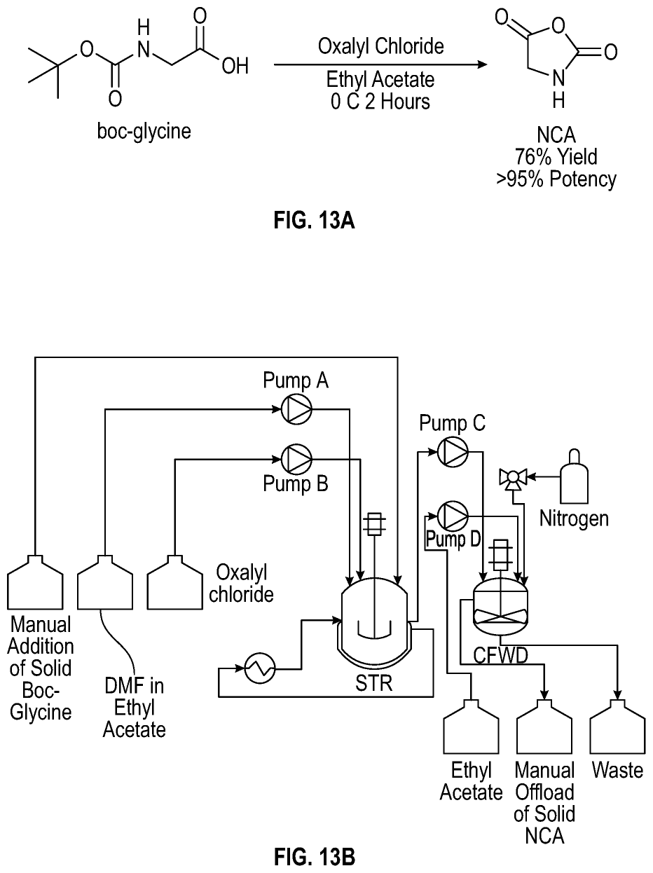

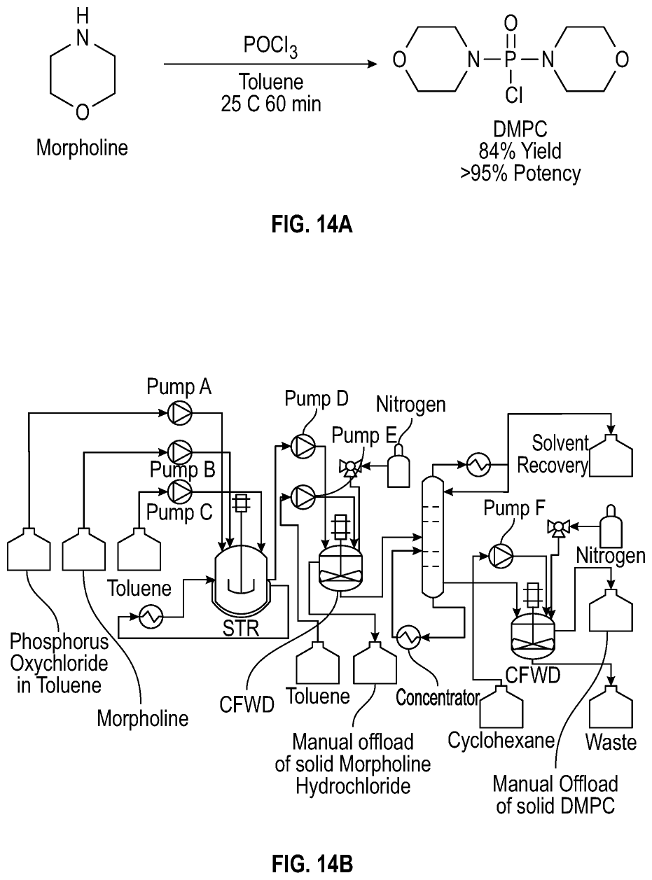

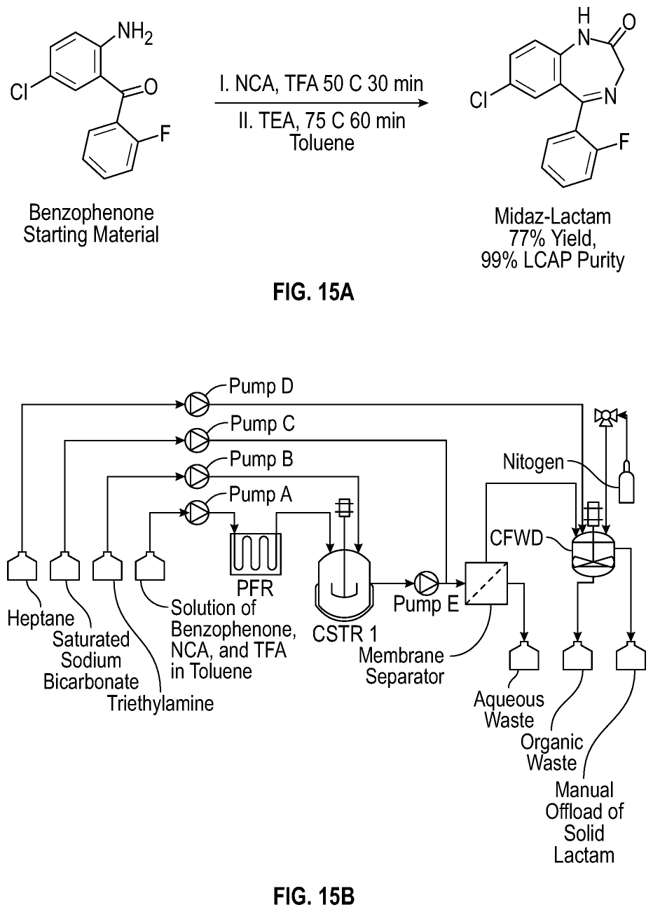

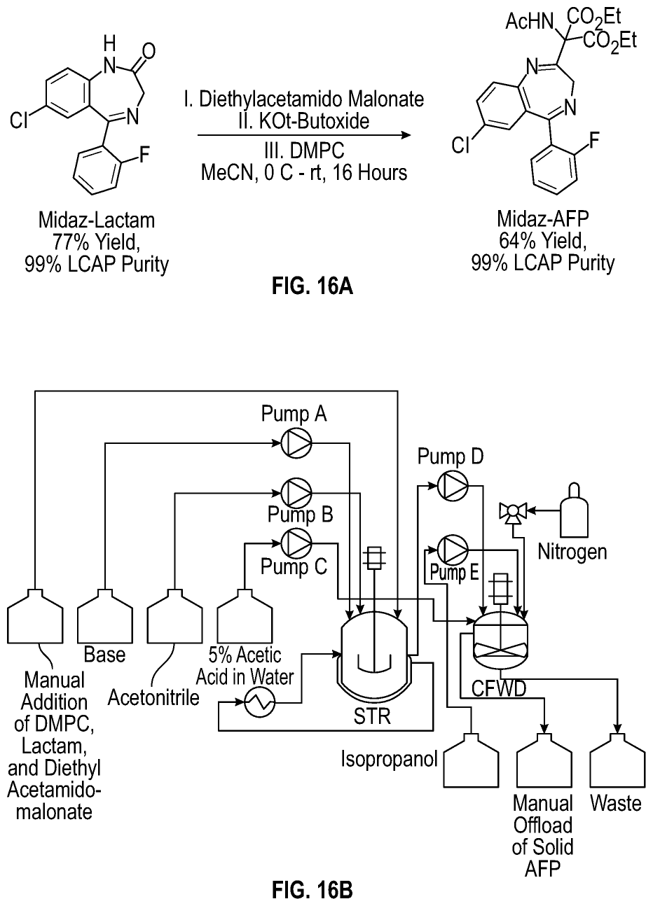

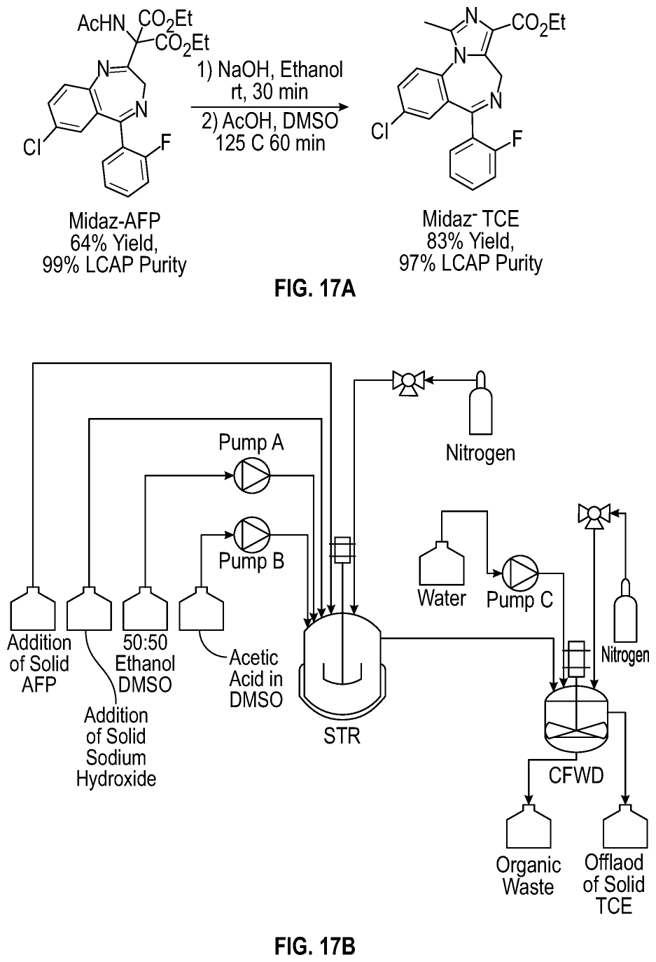

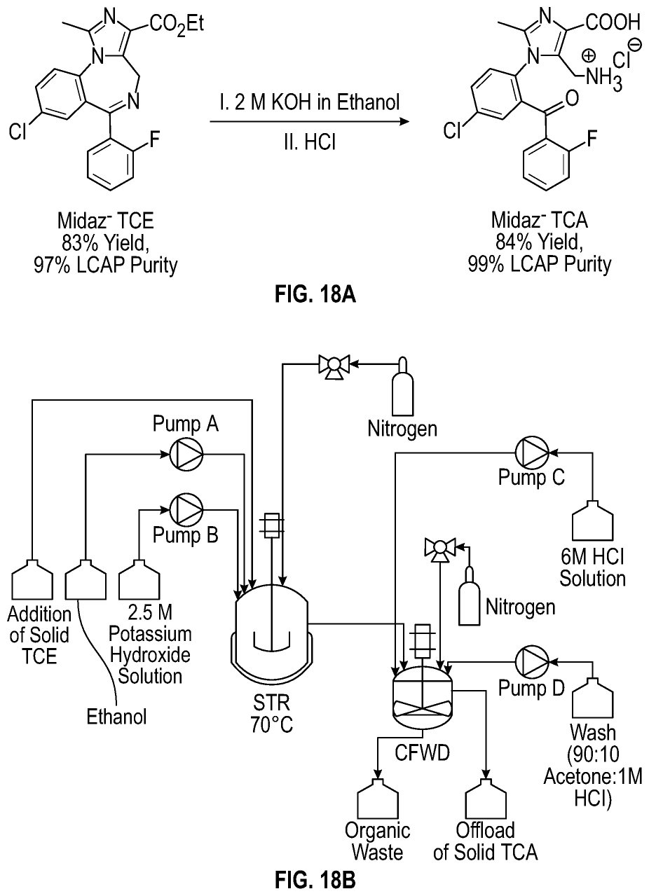

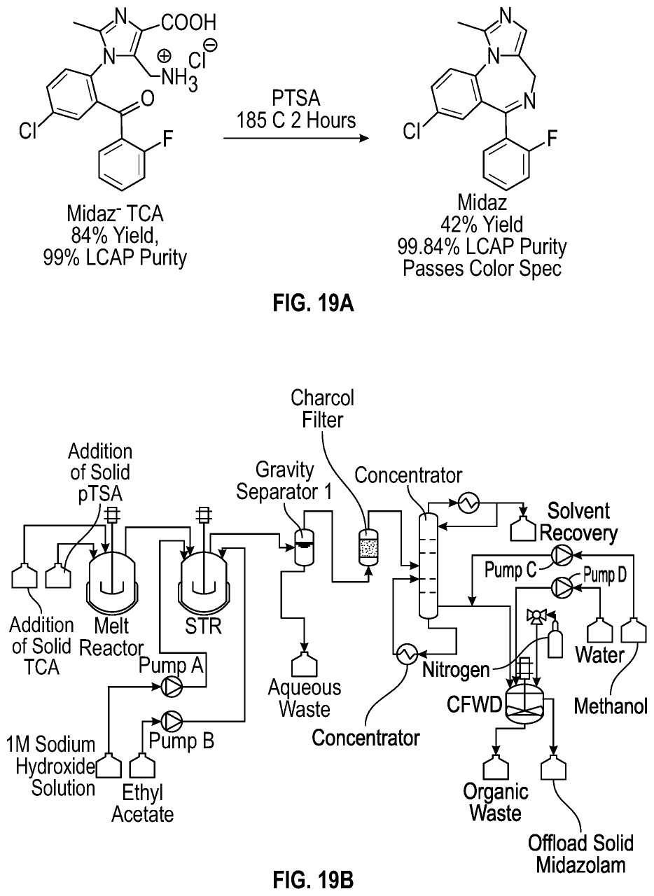

CFWD devices of the instant invention were used in multiple steps in a process for preparing midazolam depicted in FIG. 12. A CFWD device was used for isolation of NCA (FIG. 13A and FIG. 13B) and DMPC (both for removal of byproduct and isolation of solid; FIG. 14A and FIG. 14B), two reagents in the midazolam synthesis process. The CFWD device was also used to prepare all intermediates of the midazolam synthesis process. More specifically, a CFWD of the instant invention was used to isolate the lactam intermediate (FIG. 15A and FIG. 15B), the AFP intermediate (FIG. 16A and FIG. 16B), the TCE intermediate (FIG. 17A and FIG. 17B), the TCA intermediate (FIG. 18A and FIG. 18B), and finally midazolam (FIG. 19A and FIG. 19B) from the TCA intermediate.

### Example 4. Use of a CFWD Device in the Manufacture of Propofol in a Pharmaceutical on Demand (POD) Unit

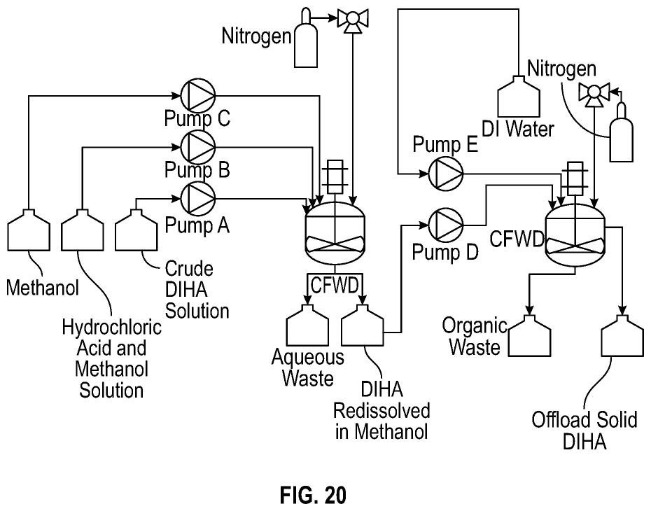

CFWD devices of the instant invention were used in a process for isolating DIHA (FIG. 20).

What is claimed is:

1. A crystallizer filter washer dryer device (100) comprising:
a. a vessel (110) defining a process chamber (111), the vessel (110) comprising vessel walls (112), a vessel opening (185), a vessel lid (113) operable to releasably seal the vessel opening (185), and a vessel base (160);
b. a filter plate (130) laterally disposed on the vessel base (160) wherein the filter plate (130) is operable to retain a crystalline fraction of a slurry comprising the crystalline fraction and a liquid fraction;
c. an agitator assembly (150) comprising:
i. an impeller (165) and agitator shaft (140), wherein the impeller (165) is laterally disposed within the vessel (110) above the filter plate (130), wherein the agitator shaft (140) is attached at agitator shaft distal end (175) to the impeller (165) in the process chamber (111) of the vessel (110) and extends through a mixing port (106) in the vessel (110) in rotatable and axially slideable relation; and
ii. a motor (145) attached to an agitator shaft distal end (175) of the agitator shaft (140) and operable to rotate the agitator shaft (140) about its longitudinal axis (180); and
d. a drain port (115) in the vessel base (160) for outflowing the liquid fraction of the slurry filtered through the filter plate (130).

2. The device of claim 1, wherein the vessel base and vessel lid are releasably sealed to the vessel walls.

3. The device of claim 1 or 2, wherein the vessel walls comprise a sealing rim at the vessel opening, and wherein the vessel lid is releasably sealed by a gasket interposed between the vessel opening and the sealing rim of the vessel walls.

4. The device of claim 3, wherein the gasket is an EPDM gasket, an FEP-encapsulated silicone gasket, a PTFE coated gasket, or a Kalrez-encapsulated gasket.

5. The device of claim 1, wherein the impeller has no predetermined direction of rotation and is vertically movable to raise and lower the impeller.

6. The device of any one of the preceding claims, wherein the impeller is operable to stir a crystallization process, keep the slurry in suspension during filtration, smoothen a filter cake's surface prior to applying spray wash, resuspend the cake during re-slurring, agitate the solids and remove cracks in the filter cake during drying, and any combination thereof.

7. The device of any one of the preceding claims, wherein the filter plate is a perforated support plate with filter mesh (metallic or non-metallic), welded multi-layer mesh, sintered wire mesh, or any combination thereof.

8. The device of any one of the preceding claims, wherein the filter plate is a sintered C-22 Hastelloy™ filter plate with Inconel™ 625 or a 1- or 5-micron Dutch Weave sintered stainless steel filter plate.

9. The device of any one of the preceding claims, wherein the vessel wall material is PEEK, Hastelloy™, Stainless Steel, glass, or HDPE, the vessel base material is PEEK, Hastelloy™, Stainless Steel, or HDPE, the seals are PTFE-coated Viton™, or any combination thereof.

10. The device of any one of the preceding claims, wherein the impeller comprises blades at a 45° angle relative to the shaft of the agitator assembly, wherein the drive mechanism comprises a 01164 NANOTEC, NEMA 23 stepper motor with encoder, and wherein the agitator assembly shaft is connected to the motor using a Ruland PCR20-8-4-SS flexible coupling.

11. The device of any one of the preceding claims, wherein the device further comprises a controller in functional communication with valves, sensors, and the agitator assembly.
